(19) United States
(12) Patent Application Publication
(10) Pub. No.: US 2023/0319642 A1
(43) Pub. Date: Oct. 5, 2023

(54) Methods and Apparatus for Application Processing in Modems

(71) Applicant: Huawei Technologies Co., Ltd., Shenzhen (CN)

(72) Inventors: Alan Gatherer, Dallas, TX (US); Hao Luan, Plano, TX (US); Ashish Rai Shrivastava, Plano, TX (US); Asheesh Kashyap, Allen, TX (US); Zhenguo Gu, The Colony, TX (US)

(21) Appl. No.: 18/325,459

(22) Filed: May 30, 2023

Related U.S. Application Data
(63) Continuation of application No. PCT/US2021/033909, filed on May 24, 2021.
(60) Provisional application No. 63/121,154, filed on Dec. 3, 2020.

(51) Int. Cl. H04W 76/18; H04L 5/00; H04W 28/20

(52) U.S. Cl. CPC H04W 28/20; H04L 5/0048; H04W 76/18

(57) ABSTRACT

Capabilities and features of a modem are specified in accordance with descriptions of applications to be executed on the modem. The specification of the modem using individual applications enables the verification of intended performance based on the individual applications, simplifying the testing and assuring of the modem. To that end, a method implemented by a cloud computing resource (CCR) includes receiving, by the CCR, a description of an application supported by a modem. A dataflow fragment (DFF) for the application is generated by the CCR and is stored by the CCR in a memory, The DFF is retrieved and provided to the modem based on a description of the modem.

### CROSS-REFERENCE TO RELATED APPLICATIONS

This application is a continuation of International Pat. Application No. PCT/US2021/033909, filed on May 24, 2021, entitled “Methods and Apparatus for Application Processing in Modems,” which claims the benefit of U.S. Provisional Application No. 63/121,154, filed on Dec. 3, 2020, entitled “A Domain Specific Language and Architecture for 5G Modem Implementation,” applications of which are hereby incorporated herein by reference in their entireties.

This application is further related to International Pat. Application No. PCT/US2021/033907, filed on May 24, 2021, entitled “Methods and Apparatus for Designing Modem Architectures.”

### TECHNICAL FIELD

The present disclosure relates generally to methods and apparatus for digital communications, and, in particular embodiments, to methods and apparatus for application processing in modems.

### BACKGROUND

Fifth generation (5G) wireless technologies require a massive number of antennas and sophisticated signal processing to improve bandwidth and spectral efficiency. New service categories, such as ultra-reliable low latency communications (URLLC), will produce new uses cases, such as self-driving automobiles, robotic factories, remote surgery, etc. The Internet of Things (IoT) is causing a proliferation in the number of connected devices. The demand is only expected to further increase for sixth generation (6G) and later forms of wireless technologies.

Addressing these challenges require a novel approach to computer design. System architects can no longer rely on faster processing cores, or even more silicon, to support the increased demand. Therefore, there is a need for methods and apparatus for designing modem architectures.

### SUMMARY

Capabilities and features of a modem are specified in accordance with descriptions of applications to be executed on the modem. The specification of the modem using individual applications enables the verification of intended performance based on the individual applications, simplifying the testing and assuring of the modem.

According to a first aspect, a method implemented by a cloud computing resource (CCR) is provided. The method provides for receiving, by the CCR, a description of an application supported by a modem, generating, by the CCR, a dataflow fragment (DFF) for the application, and storing, by the CCR, the DFF in a memory.

In a first implementation form of the method according to the first aspect, the method includes receiving, by the CCR, a description of the modem, and configuring, by the CCR, the modem in accordance with the description. The method includes providing, by the CCR, the DFF to the modem.

In a second implementation form of the method according to the first aspect or any preceding implementation form of the first aspect, the description includes an intent based description of the modem.

In a third implementation form of the method according to the first aspect or any preceding implementation form of the first aspect, the DFF is encompassed in a DFF container.

In a fourth implementation form of the method according to the first aspect or any preceding implementation form of the first aspect, the DFF includes data producer information and data consumer information.

In a fifth implementation form of the method according to the first aspect or any preceding implementation form of the first aspect, the modem includes the modem implemented as a system on a chip (SoC).

According to a second aspect, a method implemented by a modem host is provided. The method includes retrieving, by the modem host, DFFs for applications supported by a modem controlled by the modem host, and receiving, by the modem host, a first data packet associated with a first application. The method includes sending, by the modem host, a first resource request including the first data packet and a first DFF associated with the first application to at least one first resource elements of the modem.

In a first implementation form of the method according to the second aspect, the method includes receiving, by the modem host, an acceptance of the first resource request.

In a second implementation form of the method according to the second aspect or any preceding implementation form of the second aspect, the method includes receiving, by the modem host, a second data packet associated with a second application, and sending, by the modem host, a second resource request including the second data packet and a second DFF associated with the second application to at least one second resource element of the modem. The method includes determining, by the modem host, a rejection of the second resource request, and sending, by the modem host, a third resource request including the second data packet and the second DFF associated with the second application to at least one third resource element of the modem.

In a third implementation form of the method according to the second aspect or any preceding implementation form of the second aspect, the method includes by the modem host, a null DFF to at least one fourth resource element that is determined by the modem host to be idle for a period of time.

In a fourth implementation form of the method according to the second aspect or any preceding implementation form of the second aspect, the null DFF includes an instruction for the at least one fourth resource element to reduce power consumption for a time duration shorter than the period of time.

In a fifth implementation form of the method according to the second aspect or any preceding implementation form of the second aspect, the method includes adjusting, by the modem host, a performance envelope of a resource element.

In a sixth implementation form of the method according to the second aspect or any preceding implementation form of the second aspect, adjusting the performance envelope includes changing, by the modem host, a processing load on the resource element.

In a seventh implementation form of the method according to the second aspect or any preceding implementation form of the second aspect, adjusting the performance envelope includes increasing or reducing resource requests sent to the resource element.

According to a third aspect, a method implemented by a director of a resource element is provided. The method includes receiving, by the director, a first resource request including first data packets and a first DFF associated with a first application, the first DFF being generated by a computing resource in accordance with a description of the first application, and determining, by the director, acceptance of the first resource request in accordance with a DFF acceptance policy. Based upon the determining, the method includes storing, by the director, the first data packets in a buffer, and assigning, by the director, the first DFF to at least one first processing stage of the resource element.

In a first implementation form of the method according to the third aspect, the DFF acceptance policy includes at least one of an expected DFF arrival rate, an expected data arrival rate, a processing load of processing stages of the resource element, and an availability of processing stages of the resource element.

In a second implementation form of the method according to the third aspect or any preceding implementation form of the third aspect, the method includes receiving, by the director, a second resource request and second data packets of a second DFF associated with a second application, and determining, by the director, rejection of the second resource request in accordance with the DFF acceptance policy. Based upon the determining, the method includes sending, by the director, a first resource response indicating rejection of the second resource request.

In a third implementation form of the method according to the third aspect or any preceding implementation form of the third aspect, the method includes receiving, by the director, a third resource request of a first null DFF, and determining, by the director, acceptance of the third resource request in accordance with the DFF acceptance policy. Based upon the determining, the method includes assigning, by the director, the first null DFF to at least one second processing stage of the resource element.

In a fourth implementation form of the method according to the third aspect or any preceding implementation form of the third aspect, the method includes receiving, by the director, a third resource request of a first null DFF, and determining, by the director, acceptance of the third resource request in accordance with the DFF acceptance policy. Based upon the determining, the method includes assigning, by the director, the first null DFF to at least one third processing stage of the resource element.

In a fifth implementation form of the method according to the third aspect or any preceding implementation form of the third aspect, the method includes receiving, by the director, a third resource request of a first null DFF, and determining, by the director, rejection of the third resource request in accordance with the DFF acceptance policy. Based upon the determining, the method includes sending, by the director, a second resource response indicating rejection of the third resource request.

An advantage of a preferred embodiment is that the capabilities and features of a modem are specified in accordance with descriptions of applications executing on the modem. The specification of the modem using individual applications enables the verification of intended performance based on the individual applications, simplifying the testing and assuring of the modem.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a first example communications system;

FIG. 2 illustrates a model of cloud enabled exposed flow processing for a modem according to example embodiments presented herein;

FIG. 3 illustrates a diagram for the formal verification of a network service according to example embodiments presented herein;

FIG. 4 illustrates a flow diagram of example operations occurring in the verification of a model of a network service or application thereof according to example embodiments presented herein;

FIG. 5A illustrates an example dataflow graph according to example embodiments presented herein;

FIG. 5B illustrates an example dataflow graph decomposed into dataflow fragments (DFFs) and µflows according to example embodiments presented herein;

FIG. 6A illustrates a diagram providing a high-level view of an implementation of a modem according to example embodiments presented herein;

FIG. 6B illustrates a diagram presenting a detailed view of a modem host and service resource elements (SRE) according to example embodiments presented herein;

FIG. 7 illustrates a detailed view of the SRE according to example embodiments presented herein;

FIG. 8A illustrates a flow diagram of example operations occurring in a cloud computing resource configuring a modem according to example embodiments presented herein;

FIG. 8B illustrates a flow diagram of example operations occurring in a modem host participating in modem configuration and cloud operation according to example embodiments presented herein;

FIG. 8C illustrates a flow diagram of example operations occurring in a director of a SRE participating in modem configuration and cloud operation according to example embodiments presented herein;

FIG. 9A illustrates a diagram of example packets according to example embodiments presented herein;

FIG. 9B illustrates a diagram highlighting an unoptimized time-space graph for the execution of three DFFs according to example embodiments presented herein;

FIG. 9C illustrates a diagram highlighting an optimized time-space graph for the execution of three DFFs according to example embodiments presented herein;

FIG. 10 illustrates a diagram of example processing performed by and communication exchanged between entities participating in requesting resources for executing a DFF according to example embodiments presented herein;

FIG. 11 illustrates a diagram of example processing performed by and communication exchanged between entities participating in receiving data for executing a DFF according to example embodiments presented herein;

FIG. 12 illustrates a diagram of example processing performed by and communication exchanged between entities participating in executing a DFF according to example embodiments presented herein;

FIG. 13 illustrates a flow diagram of example operations occurring in a cloud computing resource participating in the execution of a DFF according to example embodiments presented herein;

FIG. 14 illustrates a flow diagram of example operations occurring in a modem host participating in the execution of a DFF according to example embodiments presented herein;

FIG. 15 illustrates a flow diagram of example operations occurring in a director of a SRE participating in the execution of a DFF according to example embodiments presented herein;

FIG. 16 illustrates a flow diagram of example operations occurring in a processing stage participating in the execution of a DFF according to example embodiments presented herein;

FIG. 17A illustrates a flow diagram of example operations occurring in a modem host inserting a null DFF according to example embodiments presented herein;

FIG. 17B illustrates a flow diagram of example operations occurring in a director executing a null DFF according to example embodiments presented herein;

FIG. 18 illustrates a diagram of interactions between director and components within a processing stage according to example embodiments presented herein;

FIG. 19 illustrates a flow diagram of example operations occurring in a stage manager of a processing stage according to example embodiments presented herein;

FIGS. 20A and 20B illustrate example token tables and actor lists of processing stages according to example embodiments presented herein;

FIG. 20C illustrates a diagram of dependencies defined in FIG. 20A according to example embodiments presented herein; and

FIGS. 21A and 21B illustrate example devices that may implement the methods and teachings according to this disclosure.

### DETAILED DESCRIPTION OF ILLUSTRATIVE EMBODIMENTS

The structure and use of disclosed embodiments are discussed in detail below. It should be appreciated, however, that the present disclosure provides many applicable concepts that can be embodied in a wide variety of specific contexts. The specific embodiments discussed are merely illustrative of specific structure and use of embodiments, and do not limit the scope of the disclosure.

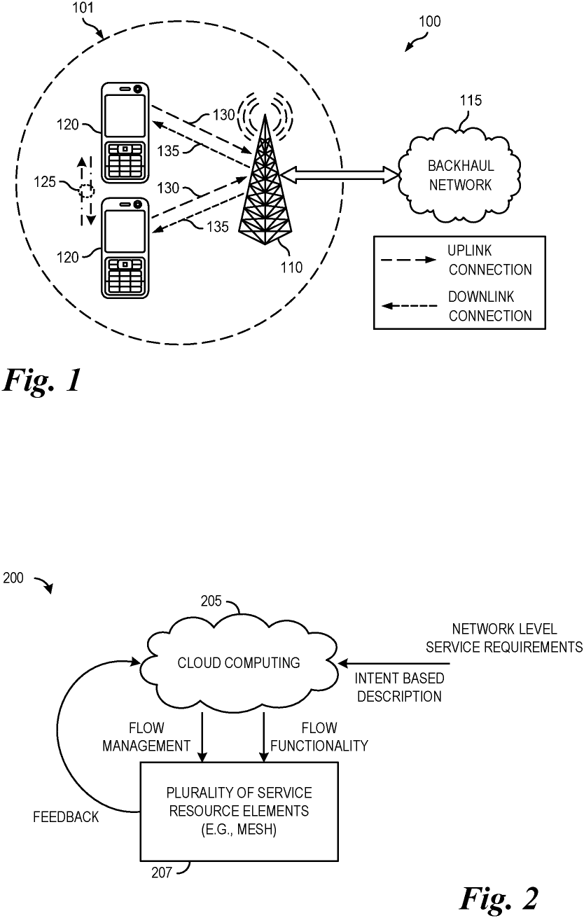

FIG. 1 illustrates a first example communications system 100. Communications system 100 includes an access node 110, with coverage area 101, serving user equipments (UEs), such as UEs 120. Access node 110 is connected to a backhaul network 115 that provides connectivity to services and the Internet. In a first operating mode, communications to and from a UE pass through access node 110. In a second operating mode, communications to and from a UE do not pass through access node 110, however, access node 110 typically allocates resources used by the UE to communicate when specific conditions are met. Communication between a UE pair in the second operating mode occurs over sidelinks 125, comprising uni-directional communication links. While communication between a UE and access node pair also occurs over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master or “primary” eNBs (MeNBs), secondary eNBs (SeNBs), master or “primary” gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

In general, the baseband modem wireless infrastructure is a specific application in a larger problem space of real-time dataflows. The baseband modem wireless infrastructure is a firm real-time system where it may be permissible to discard missed deadlines rather than breaking the system, which is the case in hard real-time systems. The baseband modem wireless infrastructure has significant control overhead if a global scheduling strategy is used for memory management and compute resource scheduling.

As the transition into fifth generation (5G) wireless systems takes place, the role of baseband is moving away from a classical embedded system to a more flexible and service oriented system. Current implementations of 5G modems struggle with excessive control overhead and massive statefulness (condition information) that makes it difficult to test and maintain the modem design. Software errors/deficiencies (“bugs”) have become a significant issue because the modem must be highly robust as the design scales. The removal of bugs during development time (as opposed to detecting the bugs during integration) seems to be the only reliable way to debug the modem design.

As an example, the increasingly flexible requirements of modems, increased data pressure on limited memory, more restrictive real-time requirements, and so on, have made it more difficult to perform system level implementation of modems. Additional features of 5G (and sixth generation (6G) and beyond), such as ultra-reliable low latency communications (URLLC), artificial intelligence, and so forth, further complicate the designing, verifying, and testing of the modem architectures.

Therefore, there is a need for new methods and apparatus for designing modem architectures that can provide flexible service oriented support of baseband processing in the modem. Furthermore, the complexity of the state space and control overhead should be managed as features and applications number and complexity increase.

According to an embodiment, methods and apparatus for cloud enabled exposed flow processing of a modem are provided. A cloud-centric view of the modem reduces the complexity of the modem by enabling the formal verification of the correctness and performance of the modem to occur in the cloud, where computing resource availability is greater and there is no real limitation on the power and size of the cloud. The modem itself may be implemented as a plurality of dataflow elements. The plurality of dataflow elements may be arranged as a mesh, for example.

The cloud has an abstract model of the modem, in which each element of the modem operates autonomously by reacting to dataflows that arrive at its input. The model may be pre-existing in the cloud or the model may be provided to the cloud by a designer or manufacturer of the modem, for example. In general, the model is a representation of the flow of data in the modem and provides a description of the processes involved in transferring data from an input to an output. The implementation of the modem as a plurality of dataflow elements, where the dataflow elements may each be configured to support one or more dataflows, minimizes and localizes control and data movement, helps to simplify the design and verification of the modem.

FIG. 2 illustrates a model 200 of cloud-enabled exposed flow processing for a modem. Model 200 includes cloud computing resources 205 that are configured to generate real-time dataflows from intent-based descriptions of network service requirements. In general, an intent-based description of the network service requirements is a non-hardware specific description of the network service requirements, and there does not have to be an immediate understanding of hardware changes or modifications in order to meet the intent-based description. Examples of an intent-based description may be reduced power consumption, improved performance, and so on. Therefore, the intent-based description provides a high-level view of goals of the network service requirements. Cloud computing resources 205 have an abstract model of the modem, which may be pre-existing at cloud computing resources 205 or the model may be provided by a designer or manufacturer of the modem, for example. As an example, the abstract model of the modem comprises a plurality of service resource elements (SREs) 207, with each SRE being capable of operating autonomously by reacting to dataflows that arrive at its input. The autonomous operation of the SREs minimizes and localizes both control and data movement. Plurality of SREs are shown in FIG. 2 as being arranged in a mesh configuration, however, other arrangements or configurations are possible, such as a grid, a ring, a star, a fully connected topology, and so on.

Cloud computing resources 205 provides the real-time dataflows that are generated from the intent based descriptions of network service requirements to plurality of SREs 207. The real-time dataflows provide dataflow functionality to SREs of plurality of SREs 207. In an embodiment, each SRE is only provided with the real-time dataflow(s) that are assigned to it. As an example, if a first SRE is assigned to perform channel estimation and if a second SRE is assigned to perform hybrid automatic repeat request (HARQ) processing, then cloud computing resource 205 provides the real-time dataflow associated with channel estimation to the first SRE and the real-time dataflow associated with HARQ processing to the second SRE. The first SRE does not receive the real-time dataflow associated with HARQ processing and the second SRE does not receive the real-time dataflow associated with channel estimation.

Cloud computing resources 205 may define flow management for each SRE of plurality of SREs 207, wherein the flow management specifies how the SRE is to react to the dataflows that arrive at its input. Typically, unless a single flow management is defined over multiple SREs, there is limited interaction between the SREs of plurality of SREs 207.

The SREs of plurality of SREs 207 provide feedback to cloud computing resources 205. Examples of the feedback may include performance feedback, SRE utilization, memory utilization, data drop information, and so on. The feedback may be used by cloud computing resources 205 to tune the flow management or flow functionality. As an example, SRE utilization may inform cloud computing resources 205 that a particular SRE is being overloaded and cloud computing resources 205 may assign an additional SRE to execute the dataflows assigned to the particular SRE to reduce the load on the particular SRE. Inversely, the SRE utilization may inform cloud computing resources 205 that the particular SRE is being underutilized. In such a situation, cloud computing resource 205 may assign additional dataflows to the particular SRE. As another example, data drop information provided to cloud computing resources 205 indicate that a particular SRE is having to drop too much data, hence cloud computing resources 205 may assign another SRE to perform the same dataflow to reduce the computational load on the particular SRE. Additionally, the feedback to cloud computing resources 205 may be used to modify the real-time dataflows generated from the intent based descriptions of network service requirements. As an example, the intent based description to reduce power consumption may have been addressed by cloud computing resources 205 by reduce data rate. However, the feedback may indicate that the reduced data rate has negatively impacted some performance measures of the modem. The cloud computing resources 205 may then alter the real-time dataflows to reduce power consumption through means other than reducing data rate.

In general, the modem has requirements for both correctness (the modem has to perform supported network service requirements correctly) and performance (the modem has to meet performance criteria). Hence, cloud computing resources 205 verifies the correctness and performance of plurality of SRE 207 based on the intent based description of the network service requirements. Cloud computing resources 205 may perform a formal verification of the correctness and performance of the modem. The purposeful limiting of the interaction between SREs simplifies the verification of the correctness and performance of the modem because the verification of individual network services is simpler than verifying multiple interacting network services. A detailed description of the formal verification is provided below.

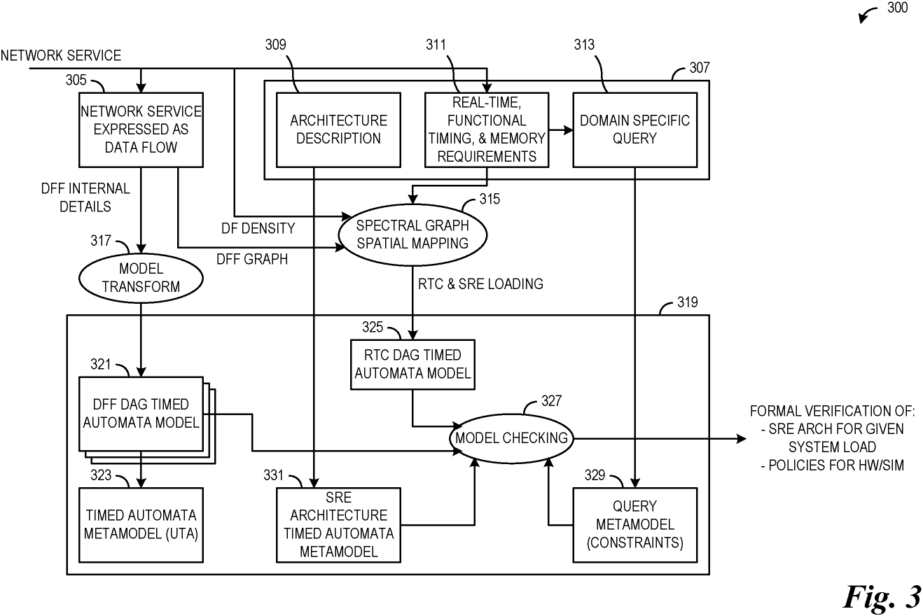

FIG. 3 illustrates a diagram 300 for the formal verification of a network service. The network service (or an application thereof), expressed as a dataflow, is partitioned into dataflow fragments (DFFs) (block 305). In an embodiment, one performing the formal verification of the network service expresses the network service as the dataflow. A computerized dataflow processing tool may be used to partition the dataflow into the DFF directed-acyclic graphs (DAGs). The partitioning of the dataflow produces DFF DAGs with derived creation patterns, producing internal details of the DFFs. In general, a tool may be a system that performs a task. A tool may comprise circuits, units, or modules.

A SRE description 307 of the SREs includes an architectural description 309 of the SREs; real-time, functional timing and memory requirements 311 of the SREs; and supported domain-specific queries 313 of the SREs. Real-time, functional timing and memory requirements 311 of the SREs make use of the description of the network service.

A spatial mapping circuit 315 maps each DFF type onto one or more SREs. The mapping by spatial mapping circuit 315 may be based on the derived creation patterns of the DFFs, a dataflow density of the network services, and real-time, functional timing and memory requirements 311 of the SREs. As an example, spectral graph theory and edge weight based heuristics may be used to perform the mapping. Satisfiability tester (SAT) and integer linear programming (ILP) may also be used. The mapping enables the development of patterns of DFF arrivals for each DFF type for each SRE. The patterns of DFF arrivals may also include patterns of data arrivals for data associated with the DFFs. As an example, the patterns of data arrivals associated with the DFF for channel estimation provides an expected pattern of arrival for the data used in channel estimation. The patterns of DFF arrivals may be used to map the DFF types onto the SREs while meeting the correctness and performance requirements, for example.

A model transform circuit 317 transforms the DFF DAGs, along with data packet and run-time ranges (which provide expected arrival times for data packets and expected run-times within an acceptable and allowable jitter), by an analysis tool 319 into a model of the network service. As an example, a DFF DAG timed automata (TA) model 321 is converted from an XML form of the DFF DAGs (that conforms to a TA metamodel 323) that is suitable for a TA analysis tool. Similarly, real-time clock (RTC) and SRE loading information (from spatial mapping circuit 315) are converted into a RTC DAG TA model 325.

Model checking 327, which combines DFF DAG TA model 321, a SRE architecture TA metamodel 331, and RTC DAG TA model 325, is performed using a set of queries from query metamodel 329. Output of model checking 327 includes a formal verification of the SRE architecture (i.e., the modem architecture) for a given system load, as well as policies for hardware or simulation. If all queries of the set of queries pass the DFF loading, the SRE architecture is considered to be formally feasible. If one or more of the queries fail, the one or more queries that fail will help to pinpoint the reason for failure, and intervention may be required to adjust the network service requirements.

In an embodiment, dataflow native methods and apparatus are provided that support complete DFFs efficiently mixing in shared memory and compute resources, as well as enforce stateless representation of flows (with records erased locally upon completion). Furthermore, security is simplified by containerizing the DFF to enable memory management stateless operations. Additionally, functional flexibility is maximized with minimal control overhead using a secured operating system.

In an embodiment, energy-based management native methods and apparatus support tooling for formal checking of performance, and manage the flow of data through memory. Additionally, flows are formally checked to manage energy, rather than utilization speculation. Furthermore, processing near or in memory is maximized.

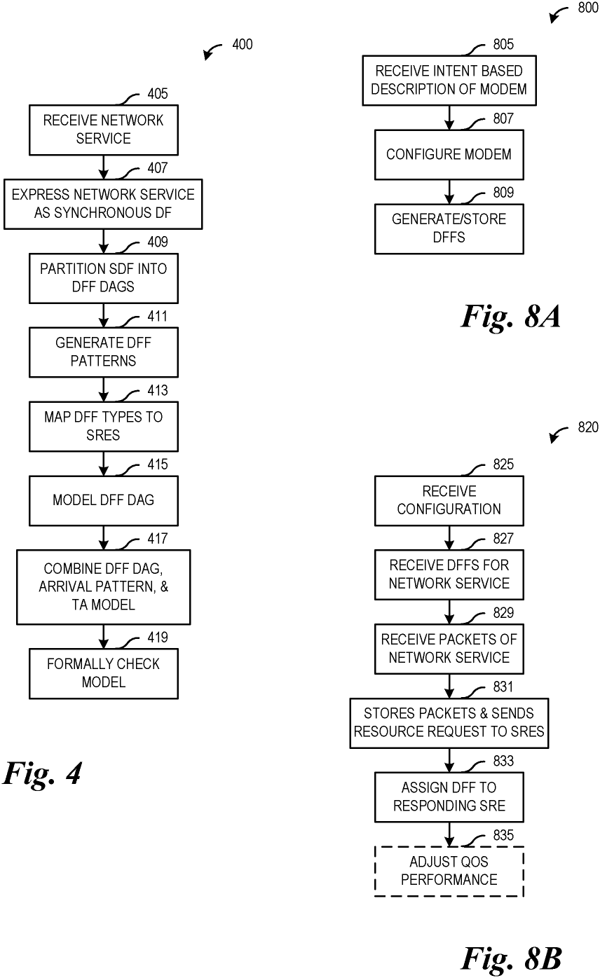

FIG. 4 illustrates a flow diagram of example operations 400 occurring in the verification of a model of a network service or application thereof. Operations 400 may be indicative of operations 400 occurring in the verification of a model of a network service or an application thereof. Operations 400 may be occurring in a verification system.

Operations 400 begin with the verification system receiving a network service or an application thereof to verify (block 405). The network service is expressed as a dataflow (block 407). The network service may be expressed as a synchronous dataflow, for example. In an embodiment, an engineer performs the formal verification of the network service as the dataflow. The dataflow is partitioned into DFF DAGs (block 409). A computerized dataflow processing tool may be used to partition the dataflow into the DFF DAGs. The partitioning of the dataflow generates DFF DAGs with derived creation patterns, producing internal details of the DFFs (block 411).

The verification system maps the DFF types to SREs (block 413). The mapping of a DFF type to one or more SREs may be static in nature. The mapping of DFF type to SREs may be performed using spectral graph theory and edge weight based heuristics, for example. Alternatively, SAT and ILP may be used to perform the mapping. The static mapping enables the development of patterns of DFF arrival for each DFF type mapped to the SREs. The patterns of DFF arrival may be statistical models for the arrival of a particular DFF type at a particular SRE, for example.

The DFF DAG is modeled (block 415). The DFF DAG, along with data packet and run-time ranges (which provide expected arrival times for data packets and expected run-times within an acceptable and allowable jitter), may be modeled by an analysis tool, for example. As an example, a DFF DAG TA model 321 is converted from an XML form of the DFF DAGs (that conforms to a TA metamodel 323) that is suitable for a TA analysis tool. Similarly, RTC and SRE loading information (from spatial mapping circuit 315) are converted into RTC DAG TA model 325.

The DFF DAGs, arrival pattern, and TA model are combined (block 417). The combining of the DFF DAGs, arrival pattern, and TA model may be combined to check the model of the network service (block 417). The checking of the model makes use of a set of queries from query metamodel 329. If all queries of the set of queries pass the DFF loading, the SRE architecture is considered to be formally feasible. If one or more of the queries fail, the one or more queries that fail will help to pinpoint the reason for failure, and intervention may be required to adjust the network service requirements.

As discussed previously, wireless baseband processing, like many other real-time workloads, may be modeled as a dataflow graph. FIG. 5A illustrates an example dataflow graph 500. In dataflow graph 500, processing is modeled by actors, which are represented as circles (such as circle A 505 (representing actor A), circle B 507 (representing actor B), and circle C 509 (representing actor C), and so on), and communication is modeled by edges, which are represented as edges or lines (such as edge 511 (representing a first input communication into circle A 505), edge 513 (representing a second input communication into circle A 505), edge 515 (representing a first output communication exiting circle A 505), edge 517 (representing a second output communication exiting circle A 505), and so forth. In general, actors produce and consume tokens, which are units of granularity of data along an edge. As an example, edge 511 is associated with 2 units of granularity of data, while edge 513 is associated with 1 unit of granularity of data.

Complicated dataflows associated with wireless baseband processing or network services (or applications associated therewith) may be decomposed into larger granularity subtasks that are referred to herein as DFFs. The DFFs may, in turn, be further decomposed into kernels or tightly coupled collections of kernels referred to as microflows (µflows). The µflows execute in a compute element, such as a processing stage of a SRE. Each kernel may comprise one or more actors and one or more edges per actor. FIG. 5B illustrates an example dataflow graph 550 decomposed into DFFs and µflows. Dataflow graph 550 may be decomposed into a first DFF 557 with µflows 559, 561, and 563, a second DFF 565 with µflows 567 and 569, and a third DFF 571 with µflows 573 and 575.

In an embodiment, the dataflow terminology enables a mapping between an abstract level of hierarchy of a dataflow graph, and a concrete level of hierarchy in actual hardware of the modem. As an example, a DFF comprises an actor at the top level of the dataflow and executes on a dataflow accelerator hardware (i.e., a SRE). As another example, a µflow comprises an actor within a DFF and executes on a single stage of the SRE. A stage of the SRE represents a logical and a physical partition of the SRE that contains the actual kernels and computational units used to execute a µflow. The table presented below summarizes the example dataflow to hardware mapping.

Table: Example Dataflow to Hardware Mapping

| | |
|---|---|
| Dataflow Abstraction Level | Hardware Mapping |
| Dataflow graph | one or more SREs |
| DFF | one SRE |
| µflow | one SRE stage |

According to an embodiment, the modem is implemented as a system on a chip (SoC). In general, a SoC is an integrated circuit or chip that integrates all or most of the components of an electronic system, which in this case, is a modem. The components include a processing unit of some type, input or output ports, storage, and so forth, on a single substrate or microchip. The integration of the components of the modem into an integrated circuit helps to improve performance and reliability, when compared to the implementation of the modem using a motherboard and replaceable components. The SoC is also typically smaller and power efficient.

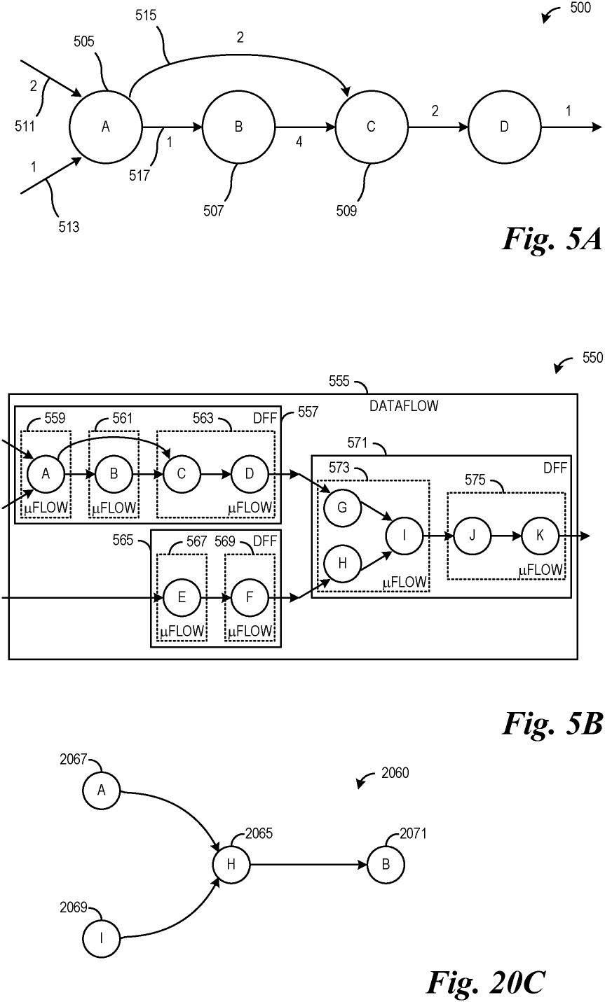

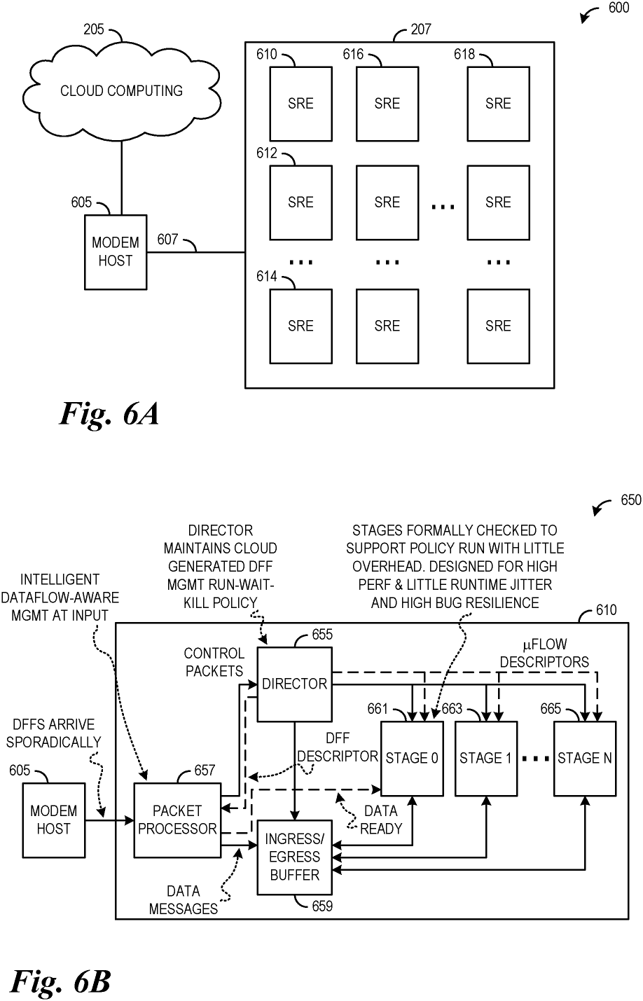

FIG. 6A illustrates a diagram 600 providing a high-level view of an implementation of a modem. Modem includes cloud computing resources 205, a modem host 605, and plurality of SREs 207. Cloud computing resources 205 may be configured to generate DFFs from network service requirements, store the DFFs, configure the modem, and so forth. In an embodiment, modem host 605 is implemented as a SoC controller or microprocessor. In an alternative embodiment, modem host 605 is implemented as a controller or microprocessor that is operatively coupled to an integrated circuit that includes plurality of SREs 207. In yet another alternative embodiment, modem host 605 is one of the SREs in plurality of SREs 207.

Plurality of SREs 207 comprises two or more SREs (such as SREs 610, 612, 614, 616, and 618), with the two or more SREs being operatively coupled to modem host 605, over connection 607. As an example, modem host 605 is connected to each of the SREs in plurality of SREs 207. In this example, modem host 605 is directly connected to the SREs in plurality of SREs 207, and connection 607 may be a cross-bar connection. As another example, modem host 605 is connected to a subset of the SREs in plurality of SREs 207, and the SREs of the subset of SREs being connected to other SREs in plurality of SREs 207. In this example, modem host 605 is directly connected only to the SREs in the subset of the SREs, and modem host 605 is indirectly connected to the other SREs in plurality of SREs 207, and connection 607 may be a partial cross-bar connection.

SoC 605 may also include storage or memory, which may be shared memory accessible by the SREs in plurality of SREs 207, distributed memory accessible only by individual SREs in plurality of SREs 207, or a combination of shared memory and distributed memory. SoC 605 may also include input ports, output ports, communication interfaces, network interfaces, and so forth.

In an embodiment, the modem comprises an array of loosely connected DFF processing elements (e.g., SREs). The SREs receive DFF control packets and DFF data, which are processed to produce outputs for the next DFF. Each DFF is a self-contained DAG that can be processed to a stateless completion, leaving only its outputs. In general, there is an arrival pattern of DFFs for each DFF flow, with the flow of DFFs simply being a continuous arrival of DFFs at a SRE, where the DFFs are grouped for convenience. Typically, the arrival pattern of DFFs is maintained, allowing for formal analysis. The SREs produce outputs from a flow within the bounds of a departure pattern. The SREs may be checked to ensure that the departure pattern is achieved.

In an embodiment, the modem host receives data associated with a network service or an application executing in the plurality of SREs, determines a DFF associated with the network service or application, sends a resource request to the plurality of SREs, and sends data associated with the network service or application to the plurality of SREs. The data associated with the network service or application arrives at the modem based on the pattern of data arrivals, which is related to a pattern of the network service or application arrivals. The modem host determines a DFF that is associated with the arrived network service or application and sends a resource request to the plurality of SREs of the modem. Although the resource request is sent to the plurality of SREs, not every SRE in the plurality of SREs receives and processes the resource request. In an embodiment, a subset of the SREs in the plurality of SREs is configured to execute the DFF, where the subset of SREs is based on the mapping of the DFF type to the SREs. Hence, the SREs in the subset of SREs are sent the resource request.

The modem host sends the data associated with the DFF to the SRE that responded affirmatively to the resource request. In a situation where more than one SRE responds affirmatively to the resource request, the modem host may randomly select one of the SREs that responded affirmatively. Alternatively, the modem host selects the SRE from the more than one SRE that responded affirmatively with the lowest loaded (e.g., smallest computational load, shortest processing queue, smallest amount of buffered data, smallest expected execution time, and so on) to execute the DFF.

In an embodiment, if the modem host receives no affirmative response from any SRE, the modem host discards the data and the associated DFF. Due to the firm real-time nature of the modem, it is possible for the modem host to discard the data and the associated DFF. However, if the modem host has to discard too much data or DFFs, the modem host may need to reconfigure the mapping of DFF types to the plurality of SREs to help decrease the likelihood of having to discard future data or DFFs, which may negatively impact performance restrictions.

In an embodiment, each SRE of the plurality of SREs includes a director that controls the operation of the SRE. As an example, the director of a SRE receives a resource request from the modem host and either accepts or rejects the resource request in accordance with a DFF acceptance policy. The DFF acceptance policy may specify rules or circumstances under which the director can accept or reject the resource request. The DFF acceptance policy may determine if any predetermined resource allocation strategies can be deployed given the current load on the processing stages of the SRE. Example DFF acceptance policy may be based on arrival time, SRE load, processing stage load, processing stage availability, memory utilization, and so on. As an example, if the resource request arrived earlier than expected, the resource request may be rejected. As another example, if the load on the SRE is greater than a threshold, the resource request may be rejected. As yet another example, if the memory utilization is greater than a threshold, the resource request may be rejected.

If the resource request is accepted, the director may send a response to the modem host indicating that the resource request has been accepted. If the resource request has been accepted by the director, the director stores corresponding data packets in buffers of the SRE.

If the resource request is rejected, the director may send a response to the modem host indicating that the resource request has been rejected. Furthermore, if the resource request is rejected, the director discards any data packets associated with the resource request and informs the modem host that the resource request has been rejected.

After the director accepts the resource request, the director assigns the DFF of the resource request to one or more processing stages of the SRE. The assignment of the DFF to the resource request to the one or more processing stages may be based on factors, including, DFF requirements, processing stage load, processing stage utilization, processing stage availability, processing stage predicted availability, and so on. As an example, if the SRE has a total of three processing stages, the director selects one (or more of the processing stages) based on the DFF requirements, and processing stage load and processing stage availability. In general, the director does not select a processing stage if it is not expected to be available when the execution of the DFF is to commence because doing so may cause the performance restrictions of the DFF to be missed.

The director may also store data associated with the DFF of the resource request in a buffer of the processing stage assigned to execute the DFF. If there is more than one processing stage assigned to execute the DFF, the director stores the appropriate data in buffer of the corresponding processing stage.

Generally, a DFF is associated with a network service or an application thereof. Hence, when a DFF is assigned to one or more processing stages, the one or more processing stages execute the DFF to perform the network service or execute the application. However, a DFF may be utilized for other purposes.

As an example, a DFF may be associated with no operations (NOPs). Such a DFF is referred to as a null DFF. In such a situation, the one or more processing stages assigned to execute the null DFF will perform no operations for a period of time associated with the null DFF. Therefore, it is possible to reduce the power consumption of the one or more processing stages. As an example, the one or more processing stages may simply gate or disable the respective clocks. As another example, the one or more processing stages may power down or enter a reduced power state.

As an illustrative example, consider a situation where the null DFF is associated with a period of time T. Then, the one or more processing stages assigned to execute the null DFF may gate their clocks or enter the reduced power state for a period of time X, where X is less than or equal to T. In general, the period of time X is less than the period of time T to ensure that the one or more processing stages are able to return to their normal operating state before resuming the execution of other assigned DFFs.

In an embodiment, the assignment of DFFs (either typical DFFs or null DFFs) proceeds in a similar manner. As an example, the modem host sends a resource request for the DFF to one or more SREs and a director of the one or more SREs accepts or rejects the resource request based on the DFF acceptance policy.

As another example, the modem host may adjust the performance of one or more SREs to adjust quality of service (QoS) requirements. The modem host may assign a larger or smaller number of DFFs to one or more SREs to adjust the response to the QoS requirements. As an example, the modem host may determine that a first QoS requirement of the modem may be violated, and as a result, the modem host assigns additional DFFs to the one or more SREs assigned to execute the DFFs related to the first QoS requirement. Assigning a greater number of DFFs to the one or more SREs will likely cause the SREs to fail the first QoS requirement. However, depending on the first QoS requirement, it may be acceptable to fail to meet the QoS requirement. As another example, the modem host may determine that a second QoS requirement of the modem may not be violated, as a result, the modem host reduces DFFs assigned to the one or more SREs assigned to execute the DFFs related to the second QoS requirement. Assigning a smaller number of DFFs to the one or more SREs will likely result in the SREs meeting the second QoS requirement.

FIG. 6B illustrates a diagram 650 presenting a detailed view of modem host 605 and SRE 610. As discussed previously, modem host 605 may be connected to plurality of SREs 207, however, FIG. 6B illustrates modem host 605 being connect to only SRE 610. The presentation and discussion of modem host 605 being connected to SRE 610 should not be construed as being limiting to the scope of the example embodiments.

SRE 610 includes a packet processor 657 configured to process packets (e.g., control packets or data packets) from modem host 605, director 655, buffers 659 configured to store incoming or outgoing data, and N+1 processing stages (e.g., stage 0 661, stage 1663, and stage N 665).

As discussed previously, director 655 processes resource requests from modem host 605, which are control packets passed on to director 655 by packet processor 657. Data received from modem host 605 are data packets and may be stored in buffers 659. If director 655 accepts a resource request from modem host 605, director 655 sends a response to the resource request to modem host 605. Director 655 also stores data associated with the DFF of the resource request to buffers 659, in locations associated with the processing stage (or stages) assigned to execute the DFF.

Director 655 provides DFF descriptors to packet processor 657. The DFF descriptor may include one or more µflows and provides information regarding the DFF. Director 655 also provides µflow descriptors to the processing stage (or stages) assigned to execute the DFF. The µflow descriptors provides information regarding the execution of the µflow by the processing stage(s), including where the processing stage(s) can obtain the data for executing the µflow, where to send output data, which execution kernel (or kernels) to use, and so on.

During execution of the DFF, the µflows in the DFF consume, process, and produce tokens. A µflow executes when all of its inputs are ready, and is complete when all of its inputs have been consumed. The µflows may send and receive tokens within the same processing stage or may be required to send and receive tokens across processing stages. However, the µflows that produce the final output tokens (i.e., the tokens that are the outputs of the DFF) send their output tokens to buffers 659. In an embodiment, a single processing stage may be simultaneously executing multiple µflows. In an embodiment, a single DFF may be assigned to be executed across multiple processing stages or SREs.

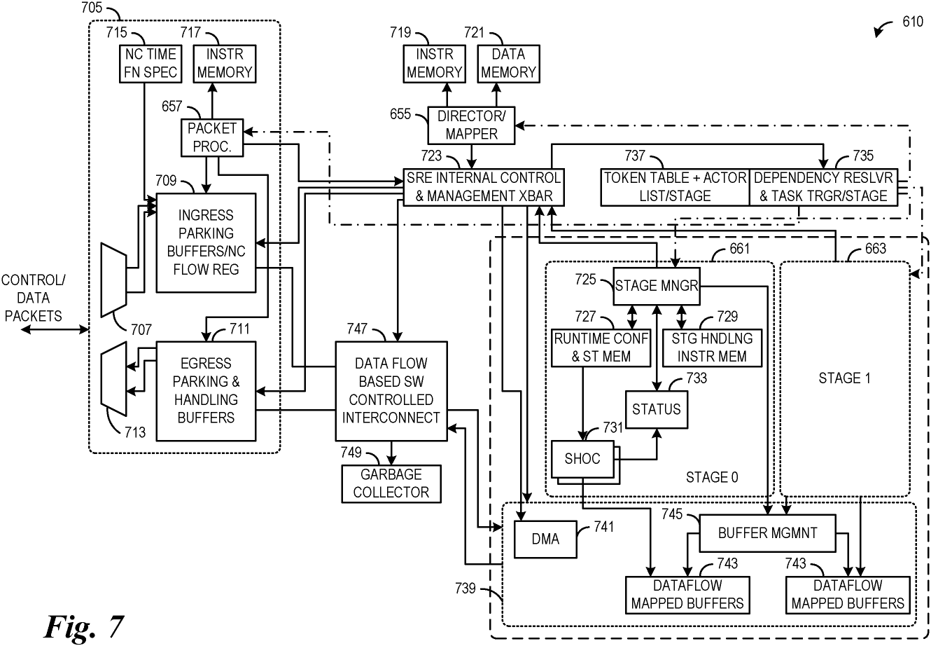

FIG. 7 illustrates a detailed view of SRE 610. SRE 610 may be designed to be highly configurable, driven by the real system requirements by the network services and applications thereof. In general, SRE 610 may be configured during an integration time when a static system specification is used to configure SRE 610. SRE 610 may also be configured during a run-time when the selection of processing stages is performed. Run-time configuration also includes the configuration of a processing engine.

SRE 610 includes packet processing subsystem 705. Packet processing subsystem 705 provides an interface between SRE 610 and the modem. Packet processing subsystem 705 includes a packet processor 657, which processing incoming or outgoing packets (control packets, data packets, or control and data packets). Incoming packets arrive at SRE 610 and are demultiplexed by demultiplexor 707 into appropriate ingress parking buffers 709. Ingress parking buffers 709 also include a network calculus (NC) flow regulator, which regulates packet flow into SRE 610. In general, NC is a mathematical theory that can be used to describe the worst case patterns of the flow of tokens in a network. As an example, the NC flow regulator may ensure that the flow rate meets a threshold (e.g., maximum flow rate or minimum flow rate). Hence, the DFF arrival pattern remains within the pattern formally checked by the cloud. DFFs arriving that violate the pattern may be rejected. Additionally, if there are too few DFFs and the DFF arrival pattern is being violated, null DFFs may be inserted. Outgoing packets leaving SRE 610 are stored at egress parking buffers 711 and are multiplexed by multiplexor 713 before leaving SRE 610. A NC time functional specification 715 stores data triggering information for assigned processing stages with ingress and egress interfaces. Instruction memory 717 stores instructions for packet processor 657 to process packets.

Director 655 (also referred to as mapper) receives and interprets control and data packets. Director 655 accepts or rejects resource requests received from modem host 605, for example, as well as assigns DFFs of accepted resource requests to processing stage(s). Director 655 also generates, populates, and terminates DFF information to the processing stages assigned. Director 655 further coordinates the admission of data packets, sets up data triggering information for the assigned processing stage(s), and orchestrates data movement after completion of the assigned DFFs. Director 655 stores instructions and internal data in instruction memory 719 and data memory 721. A control and management crossbar 723 is configured by director 655 to direct the movement of packets between packet processing subsystem 705 and the processing stages.

Control and management crossbar 723 may be responsible for control message communications between director 655, packet processor 657, and stage managers (e.g., stage manager 725) inside SRE 610. Control and management crossbar 723 carries short control messages and should have very short reactive time to ensure that important messages are routed for source to destination as quickly as possible. Control and management crossbar 723 may also route acknowledgements from destination to source to ensure that information is not dropped.

SRE 610 includes a plurality of processing stages (including, but not limited to processing stage 0 661 and processing stage 1 663). Processing stage 0 661 includes a stage manager 725 manages the general operation of processing stage 0 661. The configuration of processing stage 0 661, including DFF information and µflow information, is stored in runtime configuration and state memory 727, while instructions associated with the execution of the DFF or µflow are stored in stage handing instruction memory 729. The computational aspect of processing stage 0 661 is provided by one or more scalable hybrid and organizational computing (SHOC) elements 731. Status buffer 735 stores information, such as flags and values, representing the status of processing stage 0 661. SHOC elements 731 may be dynamically triggered by relationships defined by the DFFs, information provided by a data dependency resolver 735, and information provided by actor list and token table 737. The SHOC elements may be reconfigured during run-time by stage manager 725, based on the DFFs assigned to processing stage 0 661. Although the discussion focuses on processing stage 0 611, processing stage 1663 (as well as other processing stages in SRE 610) may be similarly configured.

As an example, each SHOC element features a hierarchical structure with a full cross bar interconnect for local small compute element (CE) groups, while a less dense cross bar structure is used for high level interconnects. As an example, each CE group contains 4 complex multiply accumulates (CMACs) of half-precision 16-bit (FP16), and is configurable as a 2x2 array or a 4x1 vector. Four CE groups comprise a CE tile, and each CE tile is connected to scratch buffers using a two-stage cross bar. A shareable thin slice of simple operators (which are capable of performing operations, such as data scaling, shifting, addition, subtraction, etc.) operate on the data passing through. Hence, expensive CMAC operators can avoid performing simple real number operations, which the compute states are reduced and the latency and storage are significantly reduced. The cores and some special function units, as well as the CE groups, can be tightly or loosely coupled. The coupling may be dependent on the algorithms and performance needs, with the goal of improving computing resource utilization. Interconnects support neighbor sharing for compute and memory resources. CE groups may be semi-statically configured and operated as an application specific integrated circuit (ASIC).

Shared buffer and memory subsystem 739 provides both a distributed and shared memory for SRE 610. Shared buffer and memory subsystem 739 interfaces with other subsystems of SRE 610 and provides data exchange support between the other subsystems of SRE 610. Shared buffer and memory subsystem 739 provides direct memory access (DMA) 741, while dataflow mapped buffers 743, which are controlled by buffer management 745, allows for exchange of data between processing stages. DMA 741 enables the efficient movement of data between multiple processing stages, as well as the modem.

Shared buffer and memory subsystem 739 may be part of an overall shared buffer memory system. Shared buffer and memory subsystem 739 operates with dataflow granularity. Shared buffer and memory subsystem 739 carry bursty and windowed traffic.

A data flow based interconnect 747 connects packet processing subsystem 705 and shared buffer and memory subsystem 739, providing direct data packet ingress and egress. Data flow based interconnect 747 may be controlled by director 655 through control and management crossbar 723.

Data flow based interconnect 747 may be responsible for data exchanges between the remainder of the modem and shared buffers in SRE 610. Data flow based interconnect 747 often conveys large amounts of data. However, any connected route may have a longer live time than a connection of control and management crossbar 723 because director 655 or packet processor 657 sets up the connections with dataflow granularity. Data flow based interconnect 747 may be considered to be a slower switching network.

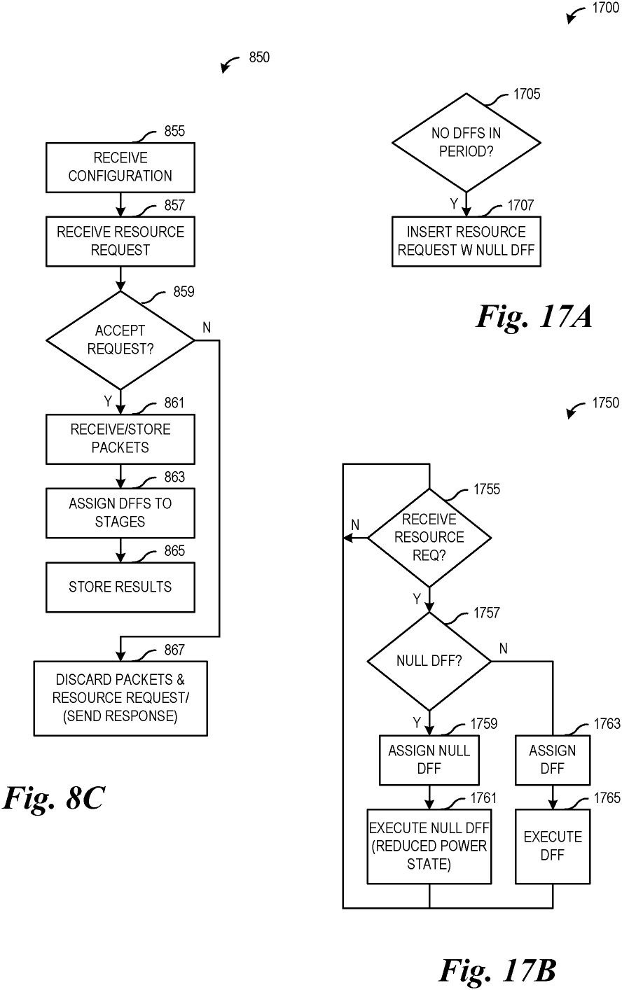

FIG. 8A illustrates a flow diagram of example operations 800 occurring in a cloud computing resource configuring a modem. Operations 800 may be occurring in the cloud computing resource that is configuring a modem based on the description of the modem.

Operations 800 begin with the cloud computing resource receiving an intent based description of the modem (block 805). The intent based description of the modem provides a description of the modem’s requirements and operations on an abstract level. The requirements of the modem may be divided into functions and principles, for example. The intent based description of the modem may not describe how to use or implement the modem. Instead, the intent based description provides sufficient guidelines or frameworks of the modem. As an example, the intent based description of the modem provides a description of the network services or applications thereof of the modem.

The cloud computing resource configures the modem (block 807). The configuration of the modem may be based on the intent based description of the modem. As an illustrative example, the cloud computing resource, using an abstract model of the modem, configures the hardware of the modem in accordance with the intent based description of the modem. The configuration of the modem specifies how the elements (e.g., SREs) of the modem react to dataflows. In an embodiment, the abstract model of the modem comprises a plurality of elements that operate autonomously and react to dataflows that arrive at their respective inputs. The autonomous nature of the elements of the modem minimizes and localizes control and data movement. The cloud computing resource also verifies the correctness and performance of the modem for the network service requirements. Part of the configuration process includes the cloud computing resource sending the configuration to the modem.

The cloud computing resource generates and stores DFFs (block 809). The DFFs are generated from the network services or applications thereof. The DFFs are also generated from service requirements. The DFFs may be generated for each of the network services or applications. The DFFs, after generation, may be stored by the cloud computing resource. The DFFs may also be provided to the modem. The modem stores the DFFs for subsequent utilization.

FIG. 8B illustrates a flow diagram of example operations 820 occurring in a modem host participating in modem configuration and cloud operation. Operations 820 may be occurring in a modem host as the modem host participates in modem configuration and cloud operation.

Operations 820 begin with the modem host receiving configuration of the modem (block 825). The configuration of the modem may be based on an intent based description of the modem. The configuration of the modem specifies how the elements (e.g., the SREs) of the modem react to dataflows. The modem host receives DFFs for network services (block 827). The modem host receives DFFs from the cloud computing resource. The modem host also receives DFF descriptors (and potentially µflow descriptors) from the cloud computing resource. The modem stores the DFFs and the DFF descriptors (and potentially µflow descriptors) in a memory.

The modem host receives packets of a network service (block 829). The packets (possibly control, data, or both control and data packets) of the network service are received by the modem host. The modem host stores the packets and sends a resource request for the network service to one or more SREs configured to execute the network service (block 831). The resource request for the particular network service may be sent to those SREs that are configured to execute the network service. If a SRE is not configured to execute the network service, the modem host does not send the resource request to the SRE. The modem host assigns the DFFs for the network service to a responding SRE (block 833). Part of the assignment involves the transfer of packets of the network service to the responding SRE. The modem host also configures the shared buffer and memory subsystem so that subsequent packets of the network service are delivered to the responding SRE. The modem host also optionally modifies the DFF assignments to adjust the QoS requirements (block 835). The modem host may assign a larger or smaller number of DFFs to one or more SREs to adjust the response to the QoS requirements. As an example, if the modem host is able to tolerate violation of a QoS requirement, the modem host assigns a larger number of DFFs to one or more SREs, causing an increase in the load on the one or more SREs and potentially resulting in a decrease in the performance related to the QoS requirement. As another example, if the modem host is unable to tolerate violation of a QoS requirement, the modem host may assign a smaller number of DFFs to one or more SREs, causing a decrease in the load on the one or more SREs and potentially resulting in an increase in the performance related to the QoS requirement.

FIG. 8C illustrates a flow diagram of example operations 850 occurring in a director of a SRE participating in modem configuration and cloud operation. Operations 850 may be occurring in a director of a SRE as the director participates in modem configuration and cloud operation.

Operations 850 begin with the director receiving the configuration of the modem (block 855). The director may receive the configuration of the SRE or the processing stages of the SRE from the modem host, for example. The configuration may specify the DFFs assigned to the SRE, DFF descriptors, µflow descriptors, and so forth. In an embodiment, the director receives the configuration of only the SRE or the processing stages of the SRE. In another embodiment, the director receives the configuration of all of the SREs (and the respective processing stages) and the director utilizes only the configuration of the SRE (and its respective processing stages).

The director receives a resource request (block 857). The resource request may be received from the modem host. The resource request comprises a request for the director to accept the assignment of the execution of a DFF (or DFFs) associated with a network service or an application thereof. The director makes a decision to accept or reject the resource request. As an example, the director makes the decision based on a DFF acceptance policy. The DFF acceptance policy may determine if any predetermined resource allocation strategies can be deployed given the current load on the processing stages of the SRE. Example DFF acceptance policy may be based on arrival time, SRE load, processing stage load, processing stage availability, memory utilization, and so on.

A check is performed to determine if the director has accepted the resource request (block 859). If the director accepts the resource request, the director receives and stores packets associated with the DFF(s) (block 861). The director may store the packets in a general buffer or direct the packets to a buffer designated for the one or more processing stages that will be executing the DFF(s). The director assigns the DFF(s) to one or more processing stages (block 863). The assignment of the DFFs to the one or more processing stages may be based on assignment factors, such as processing stage load, processing stage utilization, future processing stage load, future processing stage utilization, memory utilization, etc. The director stores the results of the execution of the DFF(s) (block 865). The results of the execution may be stored in buffers prior to being sent to the modem host. Alternatively, the results of the execution may be sent directly to the modem host by the one or more processing stages executing the DFF(s).

If the director rejects the resource request (block 859), due to the SRE being overloaded or otherwise being unable to execute the DFF(s) in a timely manner, for example, the director discards the resource request and any packets associated with the resource request already received (block 867). The director may also optionally send a response to the resource request indicating that the resource request has been rejected.

It may be possible for a SRE to receive multiple DFFs either substantially simultaneously or within a relatively short period of time. As an example, the SRE may be tasked with performing channel estimation on multiple channels. These DFFs should be managed so that they can flow freely with a guarantee of resource availability sufficient to meet their deadlines and to avoid deadlock. Because the configuration of the modem produces a DFF acceptance policy for each DFF type, the state of the modem is managed in a hierarchical manner.

In general, each dataflow receives all of its own states on input streams and produces only output streams for other dataflows. Persistent states are not allowed in the SRE for the data flows. Dataflow management is a policy that is local to the director of a SRE. The director manages arrival of the state and the data for each dataflow, as well as makes decisions based on the policy regarding when and if to release or terminate a dataflow.

Typically, how dataflows move between SREs are determine in accordance with the policy and configured during configuration using non-linear clustering algorithms, for example. As an example, spectral graph theory may be used to determine how dataflows move between SREs.

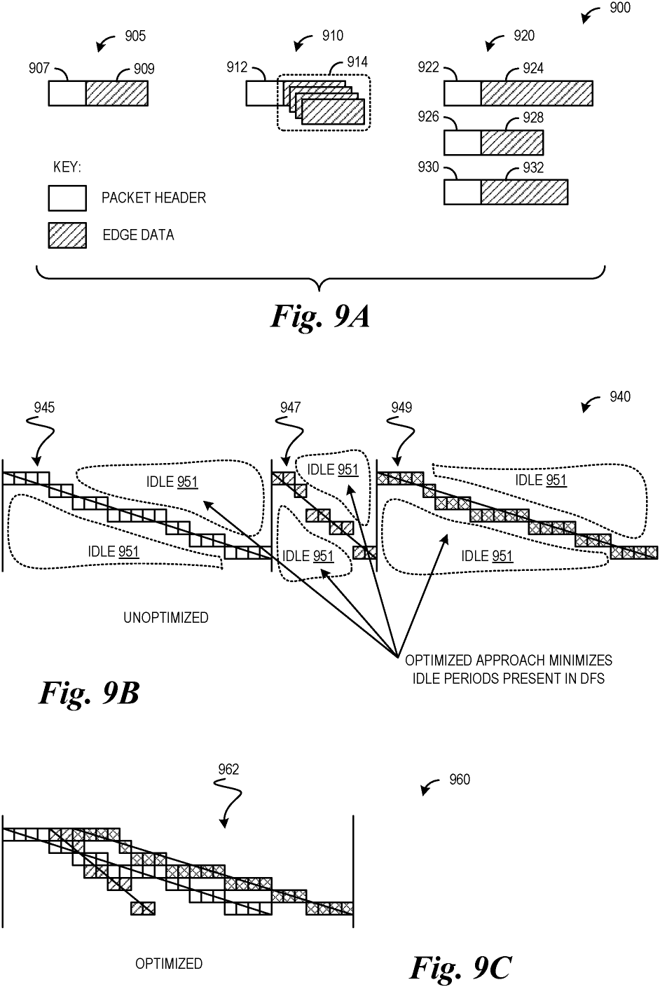

FIG. 9A illustrate a diagram 900 of example packets. The packets may comprise a single packet with single edge datum, a single packet with multiple edge data, or multiple packets with multiple edge data. A first packet 905 includes a packet header 907 and an edge datum 909. A second packet 910 includes a dataflow identifier 912 and multiple edge data 914. A third packet 920 includes multiple packets with multiple edge data, such as packet header 922 and edge data 924, packet header 926 and edge data 928, and packet header 930 and edge data 932.

The director, receiving a packet, may store edge data in buffers corresponding to the different dataflows while sending packet headers or dataflow identifiers to flow control processing. The flow control processing utilizes configured dataflow execution programs to process the edge data for the corresponding dataflows and output edge data for subsequent dataflows.

In an embodiment, the acceptance of a DFF for execution by a director of a SRE is in accordance with the DFF acceptance policy, which minimizes idle periods present in the execution of the DFFs by the processing stages of the SRE. In general, the execution of a DFF by a processing stage is a function of time and the availability of edge data of the actors of the dataflows. Hence, unless the DFF is particularly simple (e.g., with a single actor and single edge data that permits the completion of the execution of the DFF once the edge data is available), the execution of the DFF may be characterized by times associated with the execution of an actor and its associated edge data and times associated with the wait for the arrival of subsequent edge data. The execution of the DFF may be visualized as a time-space graph.

FIG. 9B illustrates a diagram 940 highlighting an unoptimized time-space graph for the execution of three DFFs. A first graph 945 (shown as clear squares) corresponds to the execution of a first DFF, a second graph 947 (shown as right-slanted shaded squares) corresponds to the execution of a second DFF, and a third graph 949 (shown as cross-hatched shaded squares) corresponds to the execution of a third DFF. As shown in FIG. 9B, the execution of a DFF completes before the execution of a subsequent DFF commences. As a result, a significant amount of the available execution time is spent idly waiting for the arrival of the edge data (shown as idle space 951).

FIG. 9C illustrates a diagram 960 highlighting an optimized time-space graph for the execution of three DFFs. A combined graph 962 corresponds to the scheduled execution of the first DFF (shown as clear squares), the second DFF (shown as right-slanted shaded squares), and the third DFF (shown as cross-hatched shaded squares) shown in FIG. 9B. As an example, the scheduler finds a sequencing of the DFFs (and µflows therein) to reduce total latency. The operation of the scheduler may be an example of temporal tessellation, in which tiles the execution of the DFFs (and µflows) to reduce gaps while preventing overlaps as a function of time. The optimized time-space graph illustrates the scheduling of the execution of the three DFFs so that the execution of a DFF does not have to complete before the commencement of the execution of a subsequent DFF. As shown in FIGS. 9B and 9C, the reduction in latency is approximately 46%.

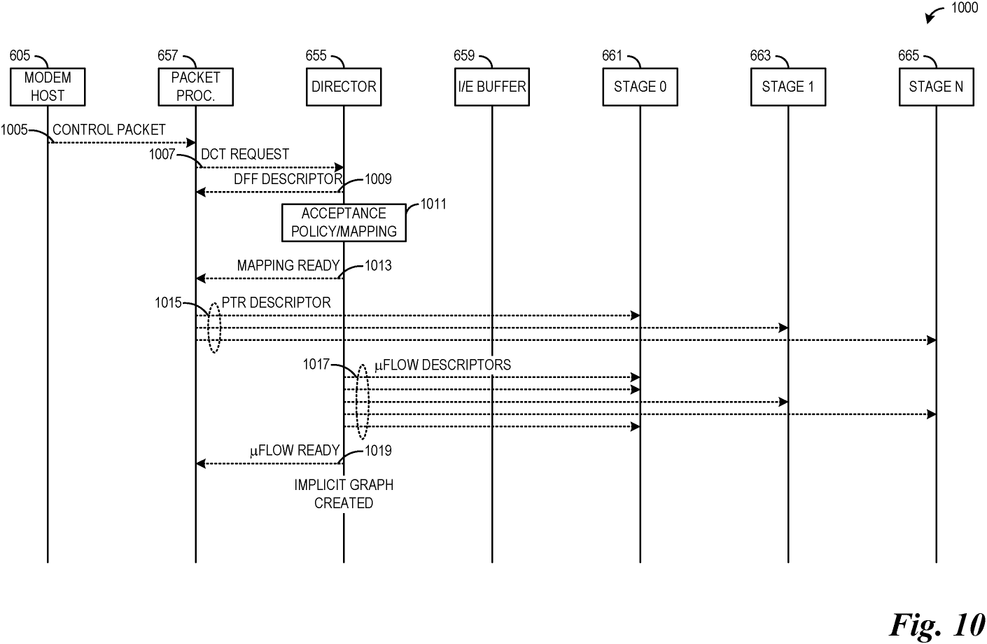

FIG. 10 illustrates a diagram 1000 of example processing performed by and communication exchanged between entities participating in requesting resources for executing a DFF. The entities performing processing and exchanging communication include modem host 605, packet processor 657, director 655, buffer 659, processing stage 0 661, processing stage 1 663, and processing stage N 665. Other examples of processing and communication may include different entities.

When modem host 605 has a DFF to process, modem host 605 sends a control packet to the SRE, which is received by packet processor 657 (event 1005). The control packet includes information regarding which resources are needed to process the DFF, for example. The control packet may include a global tag that identifies a unique instance of the DFF in the modem, as well as a container identifier that specifies the type of dataflow graph that best matches the DFF to be executed. Packet processor 657 forwards the control packet to director 655 (event 1007). The control packet may be forwarded to director 655 as a DFF container type (DCT) request, for example. If the particular DCT is supported by the SRE, director 655 sends back a DFF descriptor to packet processor 657 (event 1009). The DFF descriptor being sent back to packet processor 657 may indicate to packet processor 657 to commence sending data packets to director 655, for example. However, at this point, director 655 has not accepted the request because it has not yet determined resource requirements.

Director 655 applies the DFF acceptance policy to the request to determine if the request can be accepted by the SRE (block 1011). Director 655 also performs mapping. In order to avoid being a computational bottleneck, resource requirements of DFF containers may be pre-computed as one or more feature vectors. Director 655 examines several feature vectors associated with a DFF container to determine if any mapping will fit inside the SRE given the current system load. If no mapping is found, director 655 reports an error and instructs packet processor 657 to discard the DFF descriptor and any corresponding data. If a mapping is found, director 655 sends a mapping ready indicator (event 1013). The mapping ready indicator may be a signal or a flag, for example. Director 655 begins to load the DFF from memory, such as external memory.

The DFF may be loaded in the form of PTR descriptors and µflow descriptors (events 1015). Each µflow descriptor may contain information about the inputs of the µflow, outputs of the µflow, kernel(s) to be executed, processing stage(s) executing the µflow, and so on. µflows within the DFF may be identified using a local tag, which are statically determined. When director 655 processes the µflow descriptor during run time, director 655 appends the local tag of the DFF to the µflow descriptor, enabling the µflow instance to be identified using the global tag and the local tag. The µflow descriptors are sent to the processing stage(s) assigned to execute the µflow (events 1017). Director 655 sends a µflow ready indicator to packet processor 657 (event 1019). The µflow ready indicator may be a signal or a flag, for example. At this point, an implicit graph is generated.

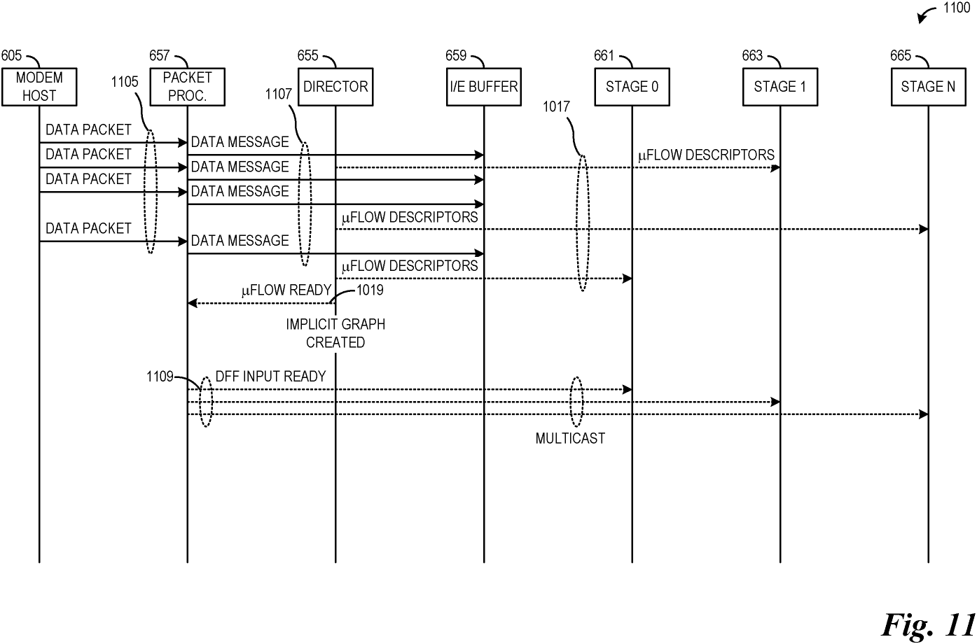

FIG. 11 illustrates a diagram 1100 of example processing performed by and communication exchanged between entities participating in receiving data for executing a DFF. The entities performing processing and exchanging communication include modem host 605, packet processor 657, director 655, buffer 659, processing stage 0 661, processing stage 1663, and processing stage N 665. Other examples of processing and communication may include different entities.

As director 655 processes µflow descriptors and sends the µflow descriptors to the processing stages in events 1017 (as presented in FIG. 10), packet processor 657 is receiving data packets (events 1105). The data packets may be received from modem host 605, for example. The data packets received by packet processor 657 are stored in buffer 659 (events 1107). The data packets may be sent from packet processor 657 to buffer 659 as data messages, for example. Packet processor 657 also sends descriptors to processing stage(s) to indicate where the inputs to the DFF are arriving. Once input data for the DFF has arrived, and µflow descriptors have been send by director 655, packet processor 657 sends a DFF input ready message to the processing stage(s) (events 1109). The DFF input ready message indicating that the DFF is ready to execute, for example.

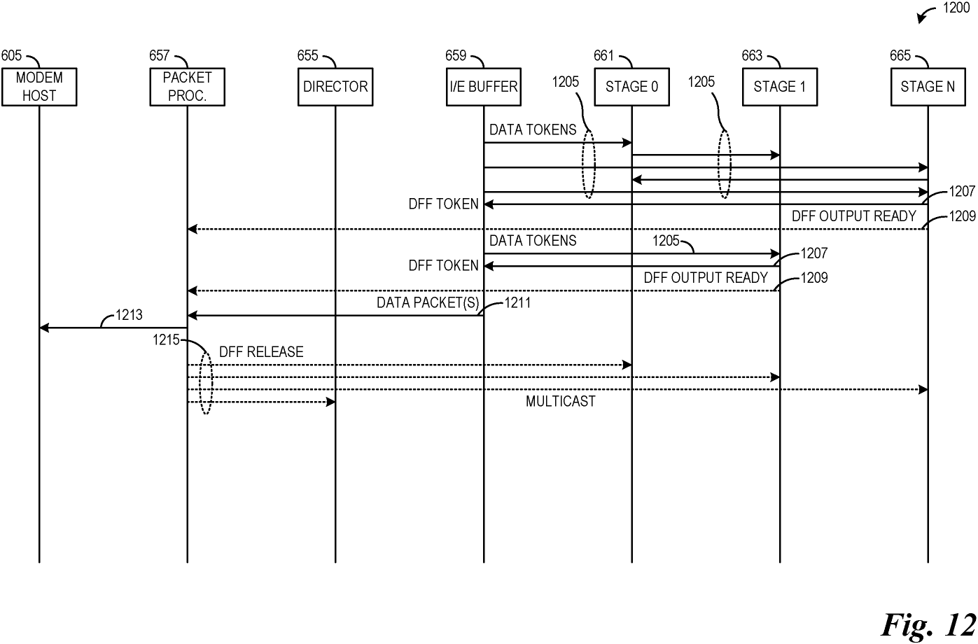

FIG. 12 illustrates a diagram 1200 of example processing performed by and communication exchanged between entities participating in executing a DFF. The entities performing processing and exchanging communication include modem host 605, packet processor 657, director 655, buffer 659, processing stage 0 661, processing stage 1 663, and processing stage N 665. Other examples of processing and communication may include different entities.

Once the input data is ready, µflows are activated and commence executing on the processing stage(s). The µflows of the DFF, executing on processing stage(s), pass intermediate tokens with a processing stage and between processing stages (events 1205). This continues until a DFF output token is produced. When a DFF output token is written to buffer 659 (event 1207), a DFF output ready indicator is sent to packet processor 657 (event 1209). The DFF output ready indicator enables packet processor 657 to keep track of the output tokens, for example. The DFF output ready indicator may be a signal or a flag. Buffer 659 also sends data packets to packet processor 657 (event 1211). Once packet processor 657 receives all DFF output tokens for the DFF, packet processor 657 sends the output data to modem host 605 (event 1213). The output data may be sent to modem host 605 in the form of data packets, for example. Packet processor 657 also sends a DFF release message (events 1215). The DFF release message indicates that the DFF has completed execution. The DFF release message may be sent to director 655, as well as the processing stages of the SRE. The DFF release message may be sent in the form of a multicast message, for example.

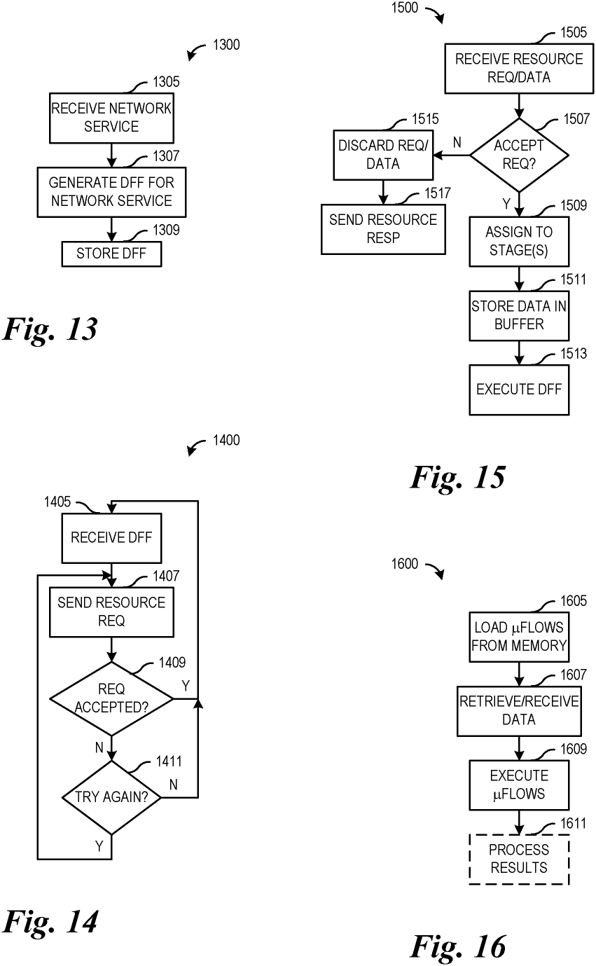

FIG. 13 illustrates a flow diagram of example operations 1300 occurring in a cloud computing resource participating in the execution of a DFF. Operations 1300 may be indicative of operations occurring in a cloud computing resource participating in the execution of a DFF by a modem.

Operations 1300 begin with the cloud computing resource receiving a network service or an application thereof (block 1305). The cloud computing resource may receive a network service supported by the modem or an application associated with the network service that is supported by the modem. The cloud computing resource generates a DFF for the network service (block 1307). The DFF being a directed acyclic graph that defines the connectivity between the kernels or µflows that execute on the processing stages of the SREs. However, due to the potentially large number of network services or applications, it may be impractical to generate a DFF for each network service or application. Hence, a number of DFF containers are defined, where a DFF container may be sufficiently large to hold the DFF associated with the network service, but not so large that there is significant overhead and inefficiency. The cloud computing resource stores the DFF (block 1309). The DFF (or DFF container) may be stored in a memory or a server, for example.

FIG. 14 illustrates a flow diagram of example operations 1400 occurring in a modem host participating in the execution of a DFF. Operations 1400 may be indicative of operations occurring in a modem host participating in the execution of a DFF.

Operations 1400 begin with the modem host receiving a DFF (block 1405). The modem host may receive the DFF associated with a network service or an application thereof from the cloud computing resource, for example. Alternatively, the modem host receives an indicator of the DFF associated with the network service or the application thereof. As another alternative, the modem host receives packets (either control, data, or both control and data) associated with the network service or the application thereof, and the packets include an identifier of the DFF. Rather than receiving the DFF or an indicator of the DFF, the modem host receives the DFF container for the DFF or an indicator of the DFF container for the DFF.

The modem host sends a resource request to the SREs of the modem (block 1407). The resource request may be sent to the SREs assigned to execute the DFF or the DFF container, for example. Sending the resource request to the SREs assigned to execute the DFF or the DFF container, communication overhead may be reduced. The modem host performs a check to determine if the resource request has been accepted (block 1409). As an example, when the DFF or DFF container is accepted for execution by a SRE, the modem host receives a response from the director of the SRE that indicates that the SRE has accepted the resource request. If the resource request has been accepted, the modem host returns to block 1405 for subsequent DFFs, as well as wait for results of the execution of the DFF or DFF container.

If the resource request has been rejected (block 1409), the modem host performs a check to determine if the modem host should repeat the resource request (block 1411). As an example, if there remains sufficient time for the DFF or the DFF container to execute and still meet real-time requirements, the modem host may repeat the resource request. If the modem host should repeat the resource request, the modem host returns to block 1407 to send the resource request. If the modem host should not repeat the resource request, the modem host discards the DFF or the DFF container and any associated packets already received. The modem host also returns to block 1405 for subsequence DFFs. In an embodiment, the modem host sends a response to the cloud computing resource to indicate that the DFF has not been executed.

FIG. 15 illustrates a flow diagram of example operations 1500 occurring in a director of a SRE participating in the execution of a DFF. Operations 1500 may be indicative of operations occurring in a director of a SRE participating in the execution of a DFF.

Operations 1500 begin with the director receiving a resource request (block 1505). The resource request requests resources for the execution of the DFF or the DFF container. The director may be the director of the SRE assigned to execute the DFF or the DFF container. Alternatively, the director receives data associated with the DFF or the DFF container. Instead of receiving the resource request for the execution of the DFF or the DFF container, the director receives data associated with the DFF or the DFF container, which initiates the process for accepting the resource request and executing the DFF or the DFF container.

The director performs a check to determine if the resource request is accepted (block 1507). As discussed previously, the director determines if the resource request is accepted in accordance with the DFF acceptance rules, where the DFF acceptance rule determines if the processing stages of the SRE are able to execute the DFF or the DFF container while meeting the real-time requirements associated with the DFF or the DFF container. If the director determines that the resource request is accepted and the SRE will execute the DFF or the DFF container, the director assigns the execution of the DFF or the DFF container to one or more processing stages (block 1509). The one or more processing stages assigned to execute the DFF or the DFF container may be identified by the DFF acceptance rules, for example.

The director stores data associated with the DFF or the DFF container in buffers associated with the processing stages that will be executing the DFF or the DFF container (block 1511). The SRE may have other processing stages that are not executing the DFF or the DFF container, and the data is not stored in buffers associated with those processing stages. The director initiates the execution of the DFF or the DFF container (block 1513). In an embodiment, the director initiates the execution of the DFF or the DFF container by sending an instruction to the processing stages assigned to execute the DFF or the DFF container. In another embodiment, the execution of the DFF or the DFF container is automatically initiated when data associated with the DFF or the DFF container is received.

FIG. 16 illustrates a flow diagram of example operations 1600 occurring in a processing stage participating in the execution of a DFF. Operations 1600 may be indicative of operations occurring in a processing stage assigned to execute the DFF or the DFF container.

Operations 1600 begin with the processing stage loading µflows of the DFF or the DFF container (block 1605). The µflows may be loaded from memory of the SRE or retrieved from a server storing the DFF or the DFF container. The processing stage retrieves or receives data of the µflows (block 1607). The processing stage may retrieve or receive the data for the µflows that is currently executing or will be executing in less than a specified amount of time. Alternatively, the processing stage may retrieve or receive the data for all of the µflows of the DFF or the DFF container, then, as the data needed for a particular µflow is retrieved or received, the execution of the particular µflow can commence. The processing stage executes the µflows (block 1609). The execution of the µflows produces data, which may be intermediate data used in execution of other µflows of the DFF or the DFF container, or final output data, which may be used by other DFFs or provided to other components of the modem or communication device. The processing stage may also process the results (block 1611). The processing stage may process the results before providing the results to other µflows or outputting the final output data.

According to an example embodiment, a DFF is used to perform power control in the modem. As discussed previously, a DFF is used to perform a network service or an application thereof. However, a DFF may also be used to perform power control. As an example, a DFF where the actors do not perform processing and where there are no data being received, generated, or transmitter, may be used to enable one or more processing stages of a SRE to enter a reduced power state to reduce power consumption. The reduced power state may be as simple as gating off the clock of the processing stages, or as complex as placing the circuitry of the processing stages into a sleep state. Such a DFF is referred to as a null DFF.

In an embodiment, the null DFF is inserted by a modem host for a SRE when the modem host detects that there is a period of time when at least one processing stage of the SRE is not executing any DFFs. The modem host may process expected arrival patterns of DFFs and data to determine such periods, for example. As an example, the modem host inserts a null DFF with a duration that is shorter than the period of time when the at least one processing stage of the SRE is not executing any DFFs to allow for sufficient time for the at least one processing stage to resume normal state before the arrival of a subsequent DFF.

FIG. 17A illustrates a flow diagram of example operations 1700 occurring in a modem host inserting a null DFF. Operations 1700 may be indicative of operations occurring in a modem inserting a null DFF when a period of inactivity is detected.

Operations 1700 begin with the modem host performing a check to determine if there is a period where there are no expected DFFs (block 1705). The check may determine if there is at least one processing stage of a SRE that is idle for a period of time. Alternatively, the check may determine if there is a SRE that is idle for a period of time. The period of time for processing stages may be different for the period of time for SREs. As an example, the period of time for processing stages may be longer than the period of time for SREs. The period of time may be specified by an operator of the modem, for example. If there is a period of time with no expected DFFs, the modem host inserts a resource request with a null DFF (block 1707). The resource request with the null DFF inserted by the modem host may have a duration that is shorter than the period of time with no expected DFFs, for example. The duration of the null DFF being shorter than the period of time with no expected DFFs will give the SREs or processing stages sufficient time to return to normal state before the arrival of a subsequent DFF.

FIG. 17B illustrates a flow diagram of example operations 1750 occurring in a director executing a null DFF. Operations 1750 may be indicative of operations occurring in a director of a SRE executing a null DFF.

Operations 1750 begin with the director performing a check to determine if a resource request has been received (block 1755). If the resource request has been received, the director performs a check to determine if the DFF or the DFF container associated with the resource request is a null DFF (block 1757). If the resource request is associated with a null DFF, the director assigns the null DFF (block 1759). The null DFF may be assigned to one or more processing stages. The assigning of the null DFF may be in accordance with the DFF acceptance rule, for example. The director initiates the execution of the null DFF (block 1761). The execution of the null DFF may involve gating the clock of the one or more processing stages. The execution of the null DFF may involve placing the one or more processing stages in a reduced power state or a sleep state.

If the resource request is not associated with a null DFF, the director assigns the DFF or the DFF container (block 1763). The assigning of the DFF may be in accordance with the DFF acceptance rule, for example. The director initiates the execution of the DFF or the DFF container (block 1765). The execution of the DFF or the DFF container by the one or more processing stages may follow the above presented process, for example.

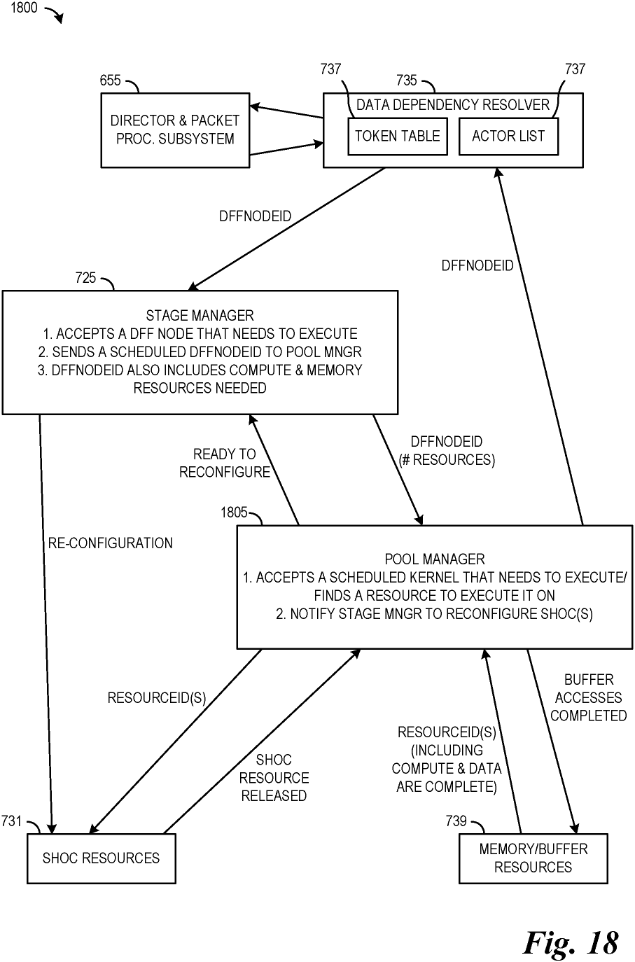

FIG. 18 illustrates a diagram 1800 of interactions between director 655 and components within a processing stage. As shown in FIG. 18, director 655 interacts with components within the processing stage through data dependency resolver 735, which includes token table and actor list 737. Components of the processing stage includes stage manager 725, pool manager 1805, SHOC resources 731, and shared buffer and memory subsystem 739.

Stage manager 725 may accept a DFF node that needs to execute from director 655, and send a DFF node identifier (DFFNODEID) to pool manager 1805, where the DFF node identifier includes compute and memory resources needed to execute the DFF node. Pool manager 1805 may accept a scheduled kernel (µflow) that is to be executed and finds a resource to execute the kernel, and notifies stage manager 725 to reconfigure SHOC elements 731 as needed.

Tasks in the processing stage include:
Run time scheduling stage manager 725 applies different scheduling algorithms (such as early deadline first, round robin, etc.) based on timing information carried in the actor list,
Resource pool management and allocation when a µflow or kernel is scheduled, stage manager 725 acts as pool manager 1805 to reserve output tokens from shared buffer memory in a processing stage. Stage manager 725 also reserves SHOC elements 731 so scheduled µflow or kernel has the resources to complete in a timely manner,
SHOC reconfiguration stage manager 725 is responsible for reconfiguring SHOC elements 731 during runtime if a new SHOC image is needed to support a function that differs from the one currently assigned. SHOC reconfiguration may occur once a DFF is assigned and pool manager 1805 has reserved resources for the scheduled µflow or kernel.

Miscellaneous tasks occurring in the processing stage include:
receiving relevant information from input arcs (such as µflow or kernel input token size),
prepare DMA transfer parameter list if DMA is required to move input tokens to other processing stages,
checking available buffer space for a processing stage and presenting the information to a scheduler and pool manager 1805 for additional decision making,
maintaining and updating a ready queue based on µflow or kernel completion status,
sending control messages to other processing stages or generating events for the processing stage once a µflow or kernel has completed successfully.

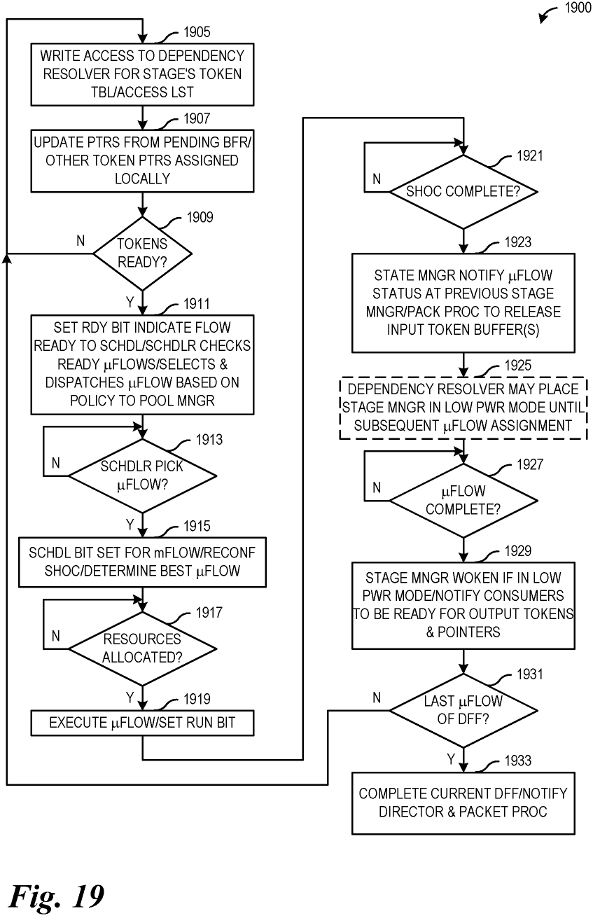

FIG. 19 illustrates a flow diagram of example operations 1900 occurring in a stage manager of a processing stage. Operations 1900 may be indicative of operations occurring in stage manager 725 of a processing stage executing a DFF.

Operations 1900 begin with write access being granted by stage manager 725 to dependency resolver 735 for token table and access list 737 of the processing stage (block 1905). Granting write access to dependency resolver 735 enables dependency resolver 735 write privilege to token table and access list 737. Dependency resolver 735 updates pointers received from the pending buffer (block 1907). Dependency resolver 735 updates only the pointers that are received from the pending buffer associated with the processing stage. Other input token pointers may be assigned locally.

A check is performed to determine if the tokens are ready (block 1909). The check may determine if all of the tokens are ready for a particular task or tasks, for example. If the tokens are not ready, stage manager 725 returns to block 1905 to grant write access to dependency resolver 735 so that dependency resolver 735 is able to update pointers received from the pending buffer.

If the tokens are ready, stage manger 725 indicates that the µflow is ready to schedule (block 1911). Furthermore, the scheduler of stage manager 725 examines ready µflows, and selects a µflow based on a queue policy (e.g., first in first out (FIFO), etc.) and dispatches the selected µflow to pool manager 1805 so pool manager 1805 is able to reserve SHOC resources 731 and output tokens.

Stage manager 725 performs a check to determine if the scheduler has picked a µflow (block 1913). If the scheduler has not picked a µflow, stage manager 725 continues to perform scheduling. If the scheduler has picked a µflow, stage manager 725 sets a bit associated with the µflow to indicate that the µflow has been selected by the scheduler (block 1915). The bit is referred to as a scheduled bit. Additionally, stage manager 725 reconfigures SHOC resources 731 based on the assignment, and selects a µflow as a best µflow. The selection of the best µflow may be based on selection policies, such as round robin, minimal energy, minimal latency, and so on. Stage manager 725 reconfigures SHOC resources 731 based on the best µflow, for example.

Stage manager 725 performs a check to determine if pool manager 1805 has allocated resources (block 1917). If pool manager 1805 has not allocated resources, stage manager 725 waits until pool manager 1805 has allocated resources. If pool manager 1805 has allocated resources, stage manager 725 initiates execution of the µflow (block 1919). Stage manager 725 may set a run bit associated with the µflow to initiate execution of the µflow, for example.

Stage manager 725 performs a check to determine if SHOC resources 731 are done executing the µflow (block 1921). If SHOC resources 731 are not done executing the µflow, stage manager 725 waits until SHOC resources 731 are done executing the µflow. If SHOC resources 731 are complete, stage manager modifies the status of the µflow (block 1923). Modification of the status of the µflow occurs at the previous stage manager or packet processor 657 so that corresponding input token buffers can be released, for example. Dependency resolver 735 may place stage manager 725 in a low power state until a subsequent invocation of the kernel assignment (block 1925).

Stage manager 725 performs a check to determine if the µflow has completed execution (block 1927). As an example, the µflow may have completed execution when SHOC resources 731 asserts or triggers a flag or condition. If the µflow has not completed execution, stage manager 725 waits until the µflow has completed execution. If the µflow has completed execution, stage manager 725 exits the low power state if it had entered the low power state (block 1929). Stage manager 725 also notifies any consumers of the output tokens of the µflow to be ready for the output tokens of the µflow and token points. As an example, stage manager 725 removes, from the actor list, an entry corresponding to the µflow from a ready queue list, resets corresponding ready, schedule, and run bits of the µflow. The µflow may now be back in the waiting state and waits for further data triggering. Stage manager 725 also releases the input buffers reserved for the completed µflow, as well as being prepared to give ownership of the output buffers to relevant triggered µflows.

Stage manager 725 performs a check to determine if the µflow is the last µflow of the DFF (block 1931). In other words, stage manager 725 checks to determine if the DFF has completed execution. If the µflow is not the last µflow of the DFF, stage manager 725 returns to block 1905 to continue the execution of the DFF by preparing the processing stage for the execution of another µflow of the DFF. If the µflow is the last µflow of the DFF, stage manager 725 completes the execution of the DFF (block 1933). The completion of the DFF may include storing output tokens, sending messages, clearing buffers, and so on. Stage manager 725 also notifies director 655 and the packet processor 675 of the completion of the execution of the DFF. As an example, a control message is sent to director 655 or packet processor 657 to notify the completion of the DFF. Examples of actions occurring after completion of the DFF include:
Setup DMA to move final results of the DFF to the other SREs of the modem and release the output token buffer space once the final results have been moved.
Retire the DFF entry deployed across multiple processing stages if the same DFF will not be executing again.

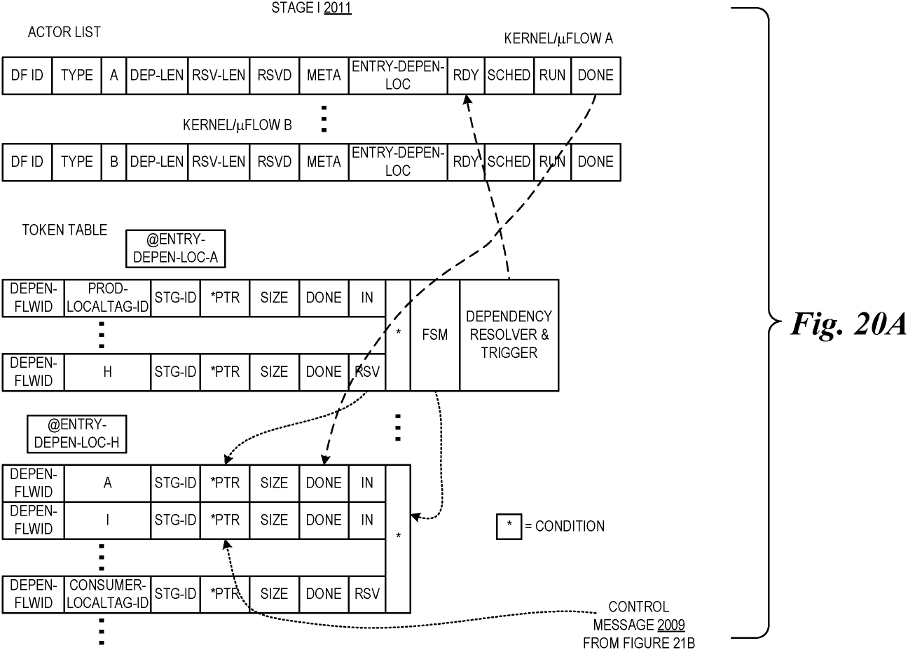

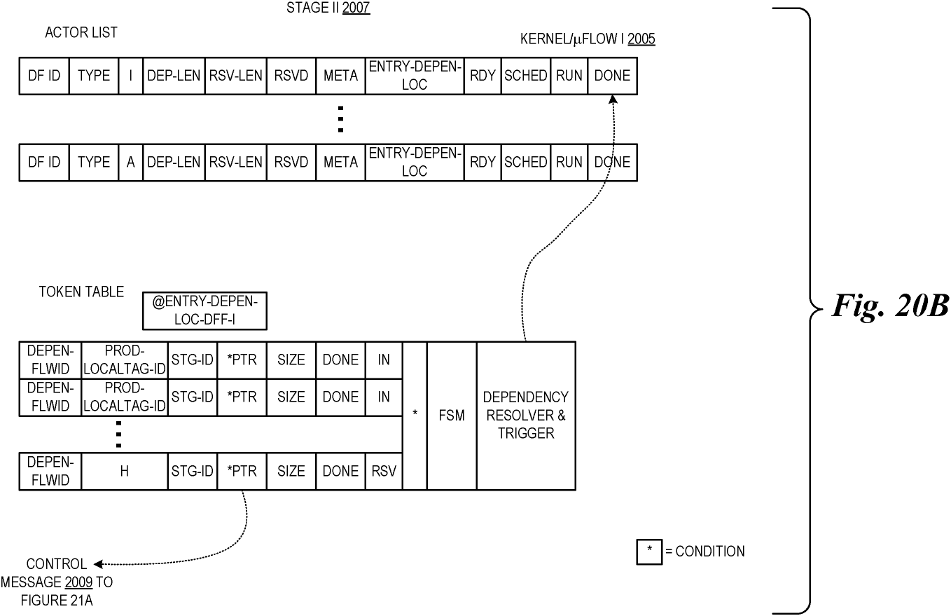

FIGS. 20A and 20B illustrate example token tables and actor lists of processing stages. As shown in FIGS. 20A and 20B, µflow I 2005 belongs to stage II 2007, and stage manager 725 (which is also located in stage II 2007) is responsible for sending a control message 2009 to stage I 2011 when µflow I 2005 completes execution. Control message 2009 is routed from stage II 2007 to stage I 2009 by way of control and management crossbar 723 and triggers dependency resolver 735 to evaluate µflows that depend on µflow I 2005. As shown in FIGS. 20A and 20B, dependency resolver 735 is located in stage I 2011.

FIG. 20C illustrates a diagram 2060 of dependencies defined in FIG. 20A. Diagram 2060 depicts the dependency among the actors and arcs defined in FIG. 20A. As an example, actor H 2065 depends on actors A 2067 and I 2069 to fire before actor H 2065 can commence operating according to its configuration. Similarly, actor B 2071 reacts only when actor H 2065 has fired.

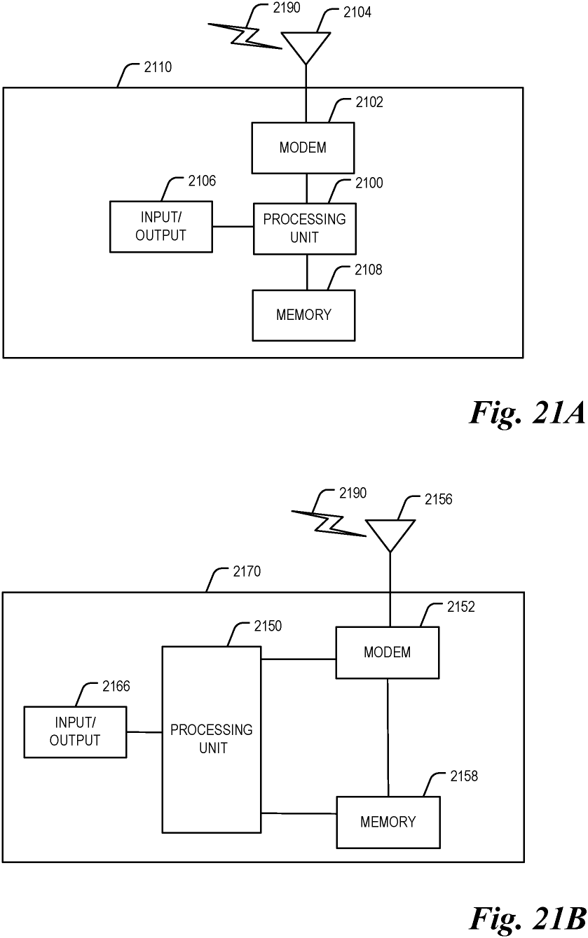

FIGS. 21A and 21B illustrate example devices that may implement the methods and teachings according to this disclosure. In particular, FIG. 21A illustrates an example ED 2110, and FIG. 21B illustrates an example base station 2170.

As shown in FIG. 21A, the ED 2110 includes at least one processing unit 2100. The processing unit 2100 implements various processing operations of the ED 2110. For example, the processing unit 2100 could perform signal coding, data processing, power control, input/output processing, or any other functionality enabling the ED 2110 to operate in a system. The processing unit 2100 also supports the methods and teachings described in more detail above. Each processing unit 2100 includes any suitable processing or computing device configured to perform one or more operations. Each processing unit 2100 could, for example, include a microprocessor, microcontroller, digital signal processor, field programmable gate array, or application specific integrated circuit.

The ED 2110 also includes at least one modem 2102. The modem 2102 may be part of a transceiver. The modem 2102 is configured to modulate data or other content for transmission by at least one antenna or NIC (Network Interface Controller) 2104. The modem 2102 is also configured to demodulate data or other content received by the at least one antenna 2104. Each modem 2102 includes any suitable structure for generating signals for wireless or wired transmission or processing signals received wirelessly or by wire. Each antenna 2104 includes any suitable structure for transmitting or receiving wireless or wired signals. One or multiple modems 2102 could be used in the ED 2110, and one or multiple antennas 2104 could be used in the ED 2110. Although shown as a single functional unit, a modem 2102 could also be implemented using at least one transmitter and at least one separate receiver.

The ED 2110 further includes one or more input/output devices 2106 or interfaces (such as a wired interface to the Internet). The input/output devices 2106 facilitate interaction with a user or other devices (network communications) in the network. Each input/output device 2106 includes any suitable structure for providing information to or receiving information from a user, such as a speaker, microphone, keypad, keyboard, display, or touch screen, including network interface communications.

In addition, the ED 2110 includes at least one memory 2108. The memory 2108 stores instructions and data used, generated, or collected by the ED 2110. For example, the memory 2108 could store software or firmware instructions executed by the processing unit(s) 2100 and data used to reduce or eliminate interference in incoming signals. Each memory 2108 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 21B, the base station 2170 includes at least one processing unit 2150, at least one modem 2152, which includes functionality for a transmitter and a receiver, one or more antennas 2156, at least one memory 2158, and one or more input/output devices or interfaces 2166. A scheduler, which would be understood by one skilled in the art, is coupled to the processing unit 2150. The scheduler could be included within or operated separately from the base station 2170. The processing unit 2150 implements various processing operations of the base station 2170, such as signal coding, data processing, power control, input/output processing, or any other functionality. The processing unit 2150 can also support the methods and teachings described in more detail above. Each processing unit 2150 includes any suitable processing or computing device configured to perform one or more operations. Each processing unit 2150 could, for example, include a microprocessor, microcontroller, digital signal processor, field programmable gate array, or application specific integrated circuit.

Each modem 2152 includes any suitable structure for generating signals for wireless or wired transmission to one or more EDs or other devices. Modem 2152 may be part of a transceiver. Each modem 2152 further includes any suitable structure for processing signals received wirelessly or by wire from one or more EDs or other devices. Although shown combined as a modem 2152, a transmitter and a receiver could be separate components. Each antenna 2156 includes any suitable structure for transmitting or receiving wireless or wired signals. While a common antenna 2156 is shown here as being coupled to the modem 2152, one or more antennas 2156 could be coupled to the modem(s) 2152, allowing separate antennas 2156 to be coupled to the transmitter and the receiver if equipped as separate components. Each memory 2158 includes any suitable volatile or non-volatile storage and retrieval device(s). Each input/output device 2166 facilitates interaction with a user or other devices (network communications) in the network. Each input/output device 2166 includes any suitable structure for providing information to or receiving/providing information from a user, including network interface communications.

It should be appreciated that one or more steps of the embodiment methods provided herein may be performed by corresponding circuits, units, or modules. For example, a signal may be transmitted by a transmitting circuit, unit, or module. A signal may be received by a receiving circuit, unit, or module. A signal may be processed by a processing circuit, unit, or module. Other steps may be performed by a determining circuit, unit, or module, a retrieving circuit, unit, or module, an assigning circuit, unit, or module, or a storing circuit, unit, or module. The respective circuits, units, or modules may be hardware, software, or a combination thereof. For instance, one or more of the circuits, units, or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of the disclosure as defined by the appended claims.

What is claimed is:

1. A method, comprising:
receiving, by a cloud computing resource (CCR), an application description of an application supported by a modem, the application description indicating requirements of a network service for the application;
generating, by the CCR, a dataflow fragment (DFF) for the application, the DFF being one of a plurality of DDFs partitioned from a network flow associated with the network service based on the application description; and
storing, by the CCR, the DFF in a memory.

2. The method of claim 1, further comprising:
receiving, by the CCR, a modem description of the modem;
configuring, by the CCR, the modem in accordance with the modem description; and
providing, by the CCR, the DFF to the modem.

3. The method of claim 2, the modem description comprising an intent based description of the modem.

4. The method of claim 1, the DFF being encompassed in a DFF container.

5. The method of claim 1, the DFF including data producer information and data consumer information.

6. The method of claim 1, the modem being implemented as a system on a chip (SoC).

7. A method, comprising:
retrieving, by a modem host, a first dataflow fragment (DFF) for a first application supported by a modem controlled by the modem host, the first DFF being one of a plurality of DDFs partitioned from a first network flow associated with a first network service based on a first application description, the first application description indicating requirements of the first network service for the first application;
receiving, by the modem host, a first data packet associated with the first application of a plurality of applications; and
sending, by the modem host, a first resource request including the first data packet and the first DFF associated with the first application to at least one first resource element of the modem.

8. The method of claim 7, further comprising:
receiving, by the modem host, an acceptance of the first resource request.

9. The method of claim 7, further comprising:
receiving, by the modem host, a second data packet associated with a second application of the plurality of applications;
sending, by the modem host, a second resource request including the second data packet and a second DFF associated with the second application to at least one second resource element of the modem;
determining, by the modem host, a rejection of the second resource request; and
sending, by the modem host, a third resource request including the second data packet and the second DFF associated with the second application to at least one third resource element of the modem.

10. The method of claim 7, further comprising:
inserting, by the modem host, a null DFF to at least one fourth resource element determined by the modem host to be idle for a period of time.

11. The method of claim 10, the null DFF including an instruction for the at least one fourth resource element to reduce power consumption for a time duration shorter than the period of time.

12. The method of claim 7, further comprising:
adjusting, by the modem host, a performance envelope of a resource element.

13. The method of claim 12, the adjusting the performance envelope comprising:
changing, by the modem host, a processing load on the resource element.

14. The method of claim 12, the adjusting the performance envelope comprising:
increasing or reducing resource requests sent to the resource element.

15. A method, comprising:
receiving, by a director of a resource element, a first resource request including first data packets and a first dataflow fragment (DFF) associated with a first application, the first DFF being generated by a computing resource in accordance with an application description of the first application, the application description indicating requirements of a network service for the first application, the first DFF being one of a plurality of DDFs partitioned from a network flow associated with the network service based on the application description;
determining, by the director, acceptance of the first resource request in accordance with a DFF acceptance policy, and based thereon,
storing, by the director, the first data packets in a buffer; and
assigning, by the director, the first DFF to at least one first processing stage of the resource element.

16. The method of claim 15, the DFF acceptance policy including at least one of an expected DFF arrival rate, an expected data arrival rate, a processing load of processing stages of the resource element, or an availability of processing stages of the resource element.

17. The method of claim 15, further comprising:
receiving, by the director, a second resource request and second data packets of a second DFF associated with a second application;
determining, by the director, rejection of the second resource request in accordance with the DFF acceptance policy; and
sending, by the director, a first resource response indicating the rejection of the second resource request.

18. The method of claim 15, further comprising:
receiving, by the director, a third resource request of a first null DFF;
determining, by the director, third acceptance of the third resource request in accordance with the DFF acceptance policy; and
assigning, by the director, the first null DFF to at least one second processing stage of the resource element.

19. The method of claim 15, further comprising:
receiving, by the director, a third resource request of a first null DFF;
determining, by the director, third acceptance of the third resource request in accordance with the DFF acceptance policy; and
assigning, by the director, the first null DFF to at least one third processing stage of the resource element.

20. The method of claim 15, further comprising:
receiving, by the director, a third resource request of a first null DFF;
determining, by the director, rejection of the third resource request in accordance with the DFF acceptance policy; and
sending, by the director, a second resource response indicating the rejection of the third resource request.
